(19) United States
(12) Patent Application Publication
(10) Pub. No.: US 2014/0243590 A1
(43) Pub. Date: Aug. 28, 2014

(54) SYSTEM AND DEVICE FOR SIMULATING INTERACTION AND THE USE OF THE SYSTEM AND DEVICE FOR SEXUAL INTERACTION

(71) Applicant: WINZZ, INC, Taipei (TW)

(72) Inventors: SHUO-WEI FANG, Taipei (TW); LU-YU CHEN, Taipei (TW); PEI-CHUN CHEN, Taipei (TW); CHENG-HSIANG HU, Taipei (TW)

(73) Assignee: WINZZ, INC, Taipei (TW)

(21) Appl. No.: 14/192,774

(22) Filed: Feb. 27, 2014

Related U.S. Application Data
(60) Provisional application No. 61/770,807, filed on Feb. 28, 2013.
(60) Provisional application No. 61/775,197, filed on Mar. 8, 2013.
(60) Provisional application No. 61/813,570, filed on Apr. 18, 2013.
(60) Provisional application No. 61/770,795, filed on Feb. 28, 2013.

(51) Int. Cl. A61H 19/00

(52) U.S. Cl. CPC A61H 19/00
USPC 600/38

(57) ABSTRACT

The present disclosure provides an interactive simulation device which can cooperate with media devices to provide a user experience of interaction between the user and a target object. An interactive simulation device of the present disclosure may exchange data with another interactive simulation device for enabling simulated interaction of senses such as tactile sense and feedback between their users across different locations. The interactive simulation device may receive motion data from other interactive simulation devices as an input of its actuator and sense the user's feedback to the motion data and send back to the interactive simulation devices. The present disclosure also provides a method and a system performing the method for simulating interaction or providing simulated interaction as a service by applying the interactive simulation device. The present disclosure further provides the application of sexual interaction and sexual stimulation of the interactive stimulation devices.

### FIELD OF THE INVENTION

The present invention relates generally to a device and a system for simulating interaction, especially tactile interaction, between people, denoted as an interactive simulation device and an interactive simulation system. More specifically, the aforementioned interaction may be sexual. Therefore, the present invention also relates to a device and a system for simulating sexual interaction, or sexual intercourse specifically. The simulation of sexual interaction and sexual intercourse may be for sexual stimulation. In other words, the present invention also relates to a sexual stimulation device and sexual stimulation system.

### BACKGROUND OF THE INVENTION

As the evolution of network technology, real-time communication between people at separate locations is enabled through the transmission of voices, images and videos over various networks. However, the behavior of interaction involves not only audiovisual communication but also other senses and feedbacks, such as tactile sense and tactile feedback, such as shaking hands and hugging. Therefore, to enable various interactive scenarios over cyberspaces, technology integrating various sense and feedbacks for remote interaction may be needed.

For example, a more realistic sexual interaction over internet may be realized with the aforementioned technology than traditional video conference call due to tactile sense plays a more important role than vision and sound in the scenario of sexual interaction. Moreover, in the aspect of sexual interaction, various kinds of sex toys are currently available for selection, such as masturbation cups, inflatable dolls, vibrators, vibrating eggs and other male or female sex toys. The aforementioned sex toys are mostly operated by their user, and the user needs to imagine a mate that the user is interacting with. However, the action of sex toys only depends on the user's operation. Therefore, the user cannot actually feel the interactive mate, and the sexual stimulation may be expectable by the user. In other words, the aforementioned sex toys do not easily let the user to interact with his or her mate remotely, and the user may feel bored and unexcited when the user operates the sex toy solitarily.

According to the above, what is needed is a system for enabling remote interaction integrated with various senses and feedbacks to bring a more interactive scenario into various applications, such as sexual interaction and stimulation.

### BRIEF SUMMARY OF THE INVENTION

In view of the foregoing subject, a general objective of the present invention is to provide a device or a system including the device for simulating interaction integrated with various senses and feedbacks, that is, an interaction simulation device comprising an interactive simulation system. More specifically, a more specific objective of the present invention is to provide a system for sexual interaction comprising an interactive sexual stimulation device.

The invention generally provides an interactive simulation device comprising a contacting part covering for tactually contacting with a target object such as human body, an actuating unit for driving movement of the contacting part relative to the target object, a sensor for sensing the feedback of the target object corresponding to the movement of the contacting part and generating sensor data correspondingly, a communication module for transmitting data and receiving data via a network and a control unit electrically connected with the actuating unit, the sensor and the communication module. The control unit is configured to receive first interaction data via the communication module and control the actuating unit to drive movement according to the first interaction data. The control unit may further be configured to receive the sensor data from the sensor, generate second interaction data according to the sensor data and control the communication module to transmit the second interaction data as response to the first interaction data. In one embodiment of the present invention, the first interaction data may come from another interactive simulation device as the output of the sensor of said another interactive device, and the second interaction data may be received by said another interactive simulation device as the input of its actuating unit. The data flow of the two interactive simulation device may form a closed loop. In another embodiment of the present invention, the first interaction data may be provided by a remote server as an on-demand interactive web service.

More specifically, the interactive simulation device may be a sexual stimulation device for stimulating sex organ, the target object, according to one embodiment of the present invention. The contacting part of the stimulation device may be a man-made sex organ composed of flexible material such as silicone rubber, and the sexual stimulation device may receive the first interaction data, drive movement of the man-made sex organ according to the first interaction data, sense feedback of the sex organ corresponding to the man-made sex organ, generate the second interaction data according to the feedback and transmit the second interaction data as response to the first interaction data.

The invention also provides a method for simulating interaction by synchronizing media data and motion data during communication with a media device and an interactive simulation device operated by the same user. A computer implemented with the method of the present invention may act as a server providing on-demand interactive web service or act as a platform bridging interactive simulation devices for remote interaction with each other. The method includes the steps of: receiving a request for interaction and identification of an interactive simulation device from a media device, retrieving first media data from a media data source, transmitting first media data to the media device for playing on the media device, receiving the address of the interactive simulation device, retrieving motion data for driving movement of the interactive simulation device corresponding to the first media data from a motion data source and transmitting the motion data to the interactive simulation device. A user operating the media device and the interactive simulation device may watch/hear the played media through the media device and feel the movement of the contacting part of the interactive simulation device according to the motion data simultaneously. Therefore, a more realistic scenario of the first media data may be provided to the user through the simultaneous movement of the contacting part of the interactive simulation device corresponding to the first media data. In addition, the aforementioned media data source and the motion data source may be another media device and another interactive simulation device respectively, and the method of the present invention may further include the steps of: receiving second media data from the media device, receiving interaction data generated by the interactive simulation device, transmitting the second media data to said another media data source and transmitting the interaction data to said another interactive simulation device for driving movement of said another interactive simulation device corresponding to the second media data.

More specifically, the interactive simulation device may be a sexual stimulation device for stimulating sex organ and the media device may be a computer with at least a display for displaying adult film received from a sever implemented with the method of the present invention. As a result, the adult film and the motion of the sexual stimulation device according to the adult film may be provided simultaneously to a user of the computer and the sexual stimulation device by performing the method of the present invention. Therefore, a more realistic and interactive scenario of watching adult film may be provided to the user. Moreover, the aforementioned media data source and the motion data source may be another computer and another sexual stimulation device respectively. Therefore, a more realistic sexual interaction may be realized by the aforementioned closed loop data flow of video data and motion data so that the user of each computer and sexual stimulation device may not only see each other but also feel each other.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIGS. 1A, 1B and 1C are schematic illustration of the system for simulating interaction comprising the interactive simulation devices according to one embodiment of the present invention;

FIGS. 2A, 2B and 2C are flowcharts of the method for simulating interaction by using the interactive simulation devices according to one embodiment of the present invention;

FIGS. 3A, 3B and 3C are schematic illustration of the system for simulating interaction comprising the interactive simulation devices according to another embodiment of the present invention;

FIGS. 4A, 4B and 4C are flowcharts of the method for simulating interaction by using the interactive simulation devices according to another embodiment of the present invention;

FIGS. 4D, 4E and 4F are flowcharts of the method for simulating interaction by using the media devices and the interactive simulation devices according to another embodiment of the present invention;

FIGS. 5A, 5B and 5C are schematic illustration of the system for providing interactive simulation to the interactive simulation device and media device according to one embodiment of the present invention;

FIGS. 6A and 6B are flowcharts of the method for providing interactive simulation to the interactive simulation device and media device according to another embodiment of the present invention;

FIGS. 7A and 7B are schematic illustration of the system for providing interactive simulation to the interactive simulation device and media device according to another embodiment of the present invention;

FIGS. 8A, 8B, 8C and 8D are flowcharts of the method for providing interactive simulation to the interactive simulation device and media device according to another embodiment of the present invention;

FIGS. 9A and 9B are schematic illustration of the interaction data exchanged between the interactive simulation devices according to one embodiment of the present invention;

FIGS. 10A and 10B are block diagrams of the interactive simulation device according to one embodiment of the present invention;

FIGS. 11A, 11B and 11C are schematic illustration of the system for simulating sexual interaction comprising the sexual stimulation devices according to one embodiment of the present invention;

FIGS. 12A, 12B and 12C are schematic illustration of the system for simulating sexual interaction comprising the sexual stimulation devices according to another embodiment of the present invention;

FIGS. 13A, 13B and 13C are schematic illustration of the system for providing interactive media content to the sexual stimulation device and media device according to another embodiment of the present invention;

FIGS. 14A, 14B and 14C are block diagrams of sexual stimulation device according to one embodiment of the present invention;

FIG. 15 is a schematic illustration of closed-loop data exchange for simulating sexual interaction between the sexual stimulation devices according to another embodiment of the present invention;

FIGS. 16A, 16B, 16C, 16D and 16E are depicting diagrams of the sexual stimulation devices according to one embodiment of the present invention;

FIGS. 17A, 17B, and 17C are depicting diagrams of the sexual stimulation devices according to another embodiment of the present invention;

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

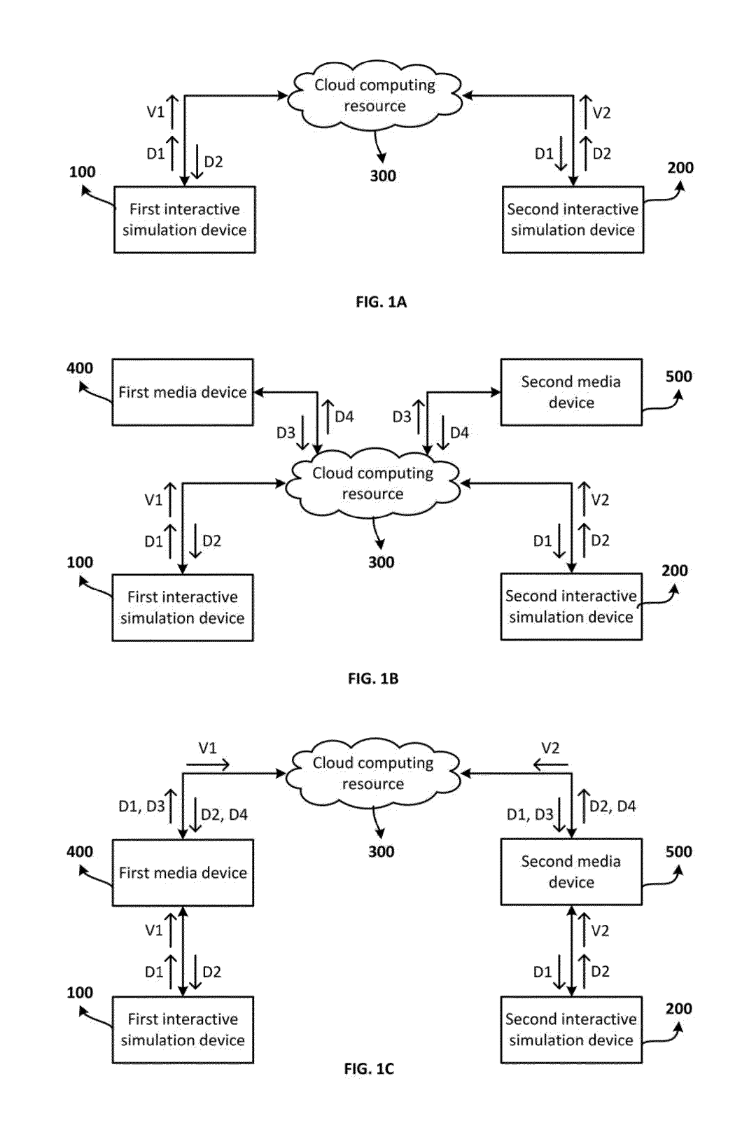

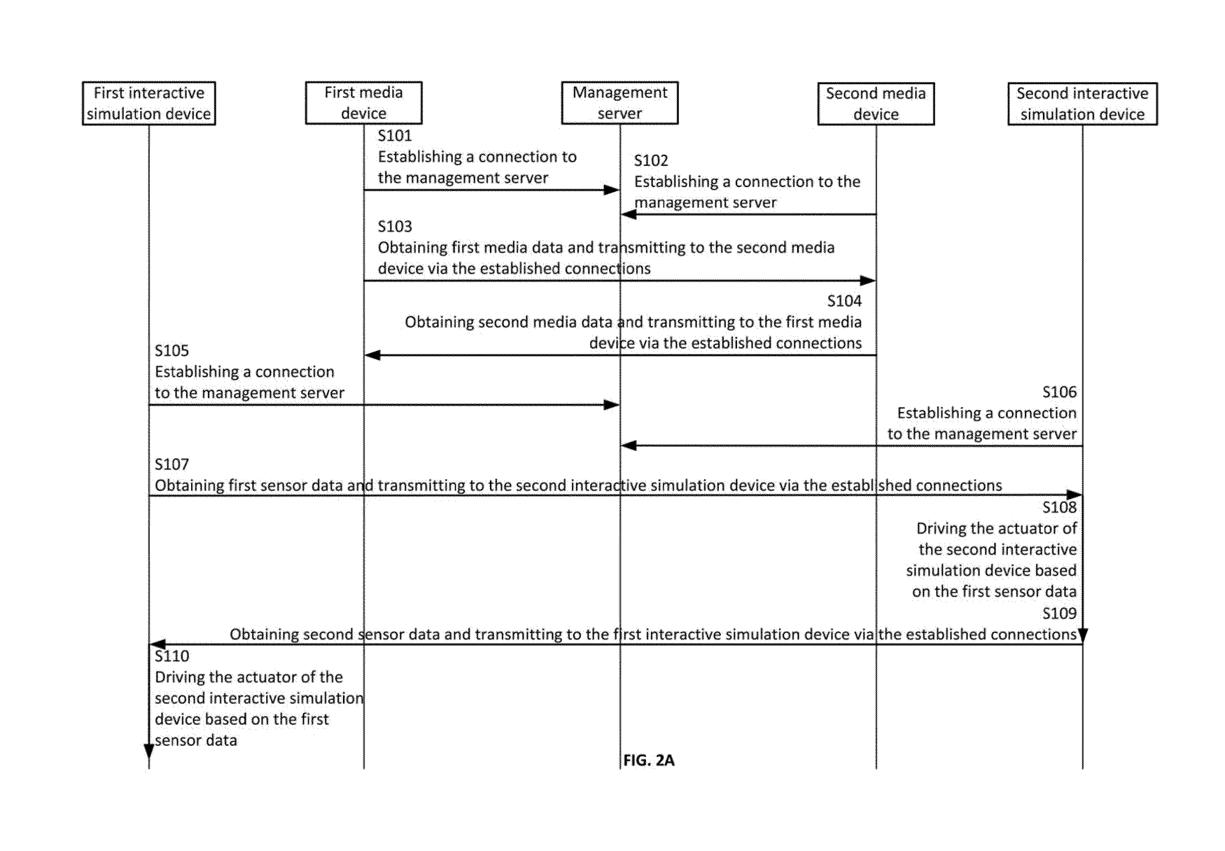

The description will be made as to the embodiments of the present invention in conjunction with the accompanying drawings in FIGS. 1A to 17C. Reference will be made to the drawing figures to describe the present invention in detail, wherein depicted elements are not necessarily shown to scale and wherein like or similar elements are designated by same or similar reference numeral through the several views and same or similar terminology.

FIG. 1A illustrates a system for simulating interaction comprising the interactive simulation devices according to one embodiment of the present invention.

Referring to FIG. 1A, the system for simulating interaction may comprise a first interactive simulation device 100, a second interactive simulation device 200 and a cloud computing resource 300. The first interactive simulation device 100 and the second interactive simulation device 200 both may communicate with the cloud computing resource 300 for data exchange. Each of the first interactive simulation device 100 and the second interactive simulation device 200 may generate interaction data D1 and D2 by sensing from the environment, transmit the interaction data D1 and D2 to each other via the cloud computing resource 300 and drive action according to the received interaction data D1 and D2. Therefore, the user of first interactive simulation device 100 may interact with a target object through the system for simulating interaction through the first interactive simulation device. It is noteworthy that the term “target object” may include physical object or virtual object (such as virtual characters or imaginary characters in media content), and the term “object” may also include live beings especially human (denoted as the user of the second interactive simulation device 200). Therefore, the users of first interactive simulation devices 100 and 200 may interact with each of their devices as if they are interacting with each other through the “closed loop” of data exchange between the interactive simulation devices 100 and 200. In one embodiment of the present invention, the validation data V1 and V2 may also be exchanged with interaction data D1 and D2 between the interactive simulation devices 100 and 200 for identifying and validating data received from each other, and wherein the validation data V1, V2 may be recorded within the interactive simulation devices 100 and 200 respectively. The validation data V1 and V2 may be user identification (UID) or device identification (DID). The user identification may include data recorded by the user of the interactive simulation devices 100 and 200, such as a user name, a password, or an e-mail. The device identification may include data preset into or acquired by the interactive simulation devices 100 and 200 such as the manufacturing number or the MAC address.

In one embodiment of the present invention, after the second interactive simulation device 200 receives the first validation data V1 and the first interaction data D1 from the first interactive device 100, the second interactive simulation device 200 may actuate according to the first interaction data D1 and send the second interaction data D2 to the first interactive simulation device 100 according to the first validation data V1. The second sexual stimulation device 12 may further verify the first validation data V1, and may actuate according to the first interaction data D1 and send the second interaction data D2 according to the verification result. Similarly, the first interactive simulation device 100 may actuate according to the second interaction D2 and send another interaction data to the second interactive simulation device 200 according to the second validation data V2 after receiving the second validation data V2 and the second interaction D2 from the second interactive simulation device 200 and verifying the second validation data V2.

FIG. 1B illustrates another system for simulating interaction comprising the interactive simulation devices according to one embodiment of the present invention.

Referring to FIG. 1B, the system for simulating interaction may include a first interactive simulation device 100, a second interactive simulation device 200, a cloud computing resource 300, a first media device 400 and a second media device 500. The first interactive simulation device 100, the second interactive simulation device 200, the first media device 400 and the second media device 500 each may communicate with the cloud computing resource 300 for data exchange. Each of the first interactive simulation device 100 and the second interactive simulation device 200 may generate interaction data D1 and D2 by sensing from the environment, transmit the interaction data D1 and D2 to each other via the cloud computing resource 300 and drive action according to the received interaction data D1 and D2. In addition, each of the first media device 400 and the second media device 500 may generate media data D3 and D4 by capturing from the environment, transmit the interaction data D3 and D4 to each other via the cloud computing resource 300 and output the received media data D3 and D4. Therefore, the user of first interactive simulation device 100 and the first media device 400 may interact with a target object through the system for simulating interaction through the first interactive simulation device. It is noteworthy that the term “target object” may include physical object or virtual object (such as virtual characters or imaginary characters in media content), and the term “object” may also include live beings especially human (denoted as the user of the second interactive simulation device 200 and the second media device 500). That is, the user of the first media device 400 and the first interactive simulation devices 100 and the user of the second media device 500 and the second interactive simulation device 200 may interact with each of their devices as if they are interacting with each other through the “closed loop” of data exchange between the media devices 400, 500 and the interactive simulation devices 100, 200. In one embodiment of the present invention, the aforementioned media data D3 and D4 may include video data and/or audio data including the video and/or the voice of the user captured by the media devices 400 and 500 respectively. In another embodiment of the present invention, the media data D3 and D4 may include instant messages comprising images and texts inputted by the user. It is comprehensive for the person of ordinary skills to understand that the interaction data D1 and D2 may not have the same type of data. For example, the first interaction data D1 may be motion data for driving a motor in the second interactive simulation device 200 and the second interaction data D2 may be a frequency data for driving a vibrator in the first interactive simulation device 100. Similarly, the interaction data D1 and D2 may not have the same type of data. For example, the first media data D3 may be video data and the second media data D4 may be instant messages comprising texts and images.

In one embodiment, the cloud computing resource 300 may allow the users of the media device to create virtual characters to represent themselves in the cyberspace and store the virtual characters. The cloud computing resource 300 may provide various functions to the virtual characters for entertainment. For example, the virtual characters may be able to be raised by the users. The users may be able to feed and dress the virtual characters for them to grow up. The media data D3 and D4 each may comprise a streaming data set of the aforementioned virtual character of the user produced by the cloud computing resource 300 respectively instead of the first media device 400 and the second media device 500. The first media device 400 or the first interactive simulation device 100 may transmit commands, which may be included in the first interaction data D1, to the cloud computing resource 300 for controlling the virtual character, and the cloud computing resource 300 produces the first media data D3 including the virtual character with motions according to the commands. The second media device 500 may receive the media data D3 including the virtual character with motions, and the second interactive simulation device 200 may receive the first interaction data D1 at the same time. Similarly, the user of the second media device 500 and the second interactive simulation device 200 may send the second interaction data D2 and the second media data D4 including another virtual character with motions corresponding to the second interaction data D2 to the first media device 400 and the first interactive simulation device 100. In addition, each of the first interactive simulation device 100 and the second interactive simulation device 200 may comprise an actuator for performing actions according to the received interaction data D1 and D2. Therefore, users of the first media device 400, the first interactive simulation device 100 and the second media device 500, the second interactive simulation device 200 may interact with each other through virtual characters in the cyberspace and may feel the motions of each other's virtual character through the interactive simulation devices 100 and 200.

FIG. 1C illustrates another system for simulating interaction comprising the interactive simulation devices according to one embodiment of the present invention. Referring to FIG. 1C, the system for simulating interaction may include the first interactive simulation device 100, the second interactive simulation device 200, the cloud computing resource 300, the first media device 400 and the second media device 500. The main difference between the system illustrated in FIG. 1B and FIG. 1C is the interaction data D1 and D2 in FIG. 1C is transmitted to the interactive simulation devices 100 and 200 via the media devices 400 and 500 respectively. In one embodiment of the present invention, the interaction data D1 and D2 may be encoded into the media data D3 and D4 respectively and transmitted to the media devices 400 and 500. The media devices 400 and 500 may retrieve the interaction data D1 and D3 from the received media data D3 and D4 and transmitted to the interactive simulation devices 100 and 200. In one embodiment of the present invention, the media data D3 and D4 may be streaming video and audio data, and wherein the interaction data D1 and D2 may be encoded within the audio data of the media data D3 and D4 respectively especially encoded within audio data corresponding to specific frequency of sound. In addition, one embodiment of the present invention, the interactive simulation devices 100 and 200 each may have a microphone for detecting the sound in the specific frequency to retrieve the interaction data D1 and D2 respectively while the media devices 400 and 500 playing the media data D3 and D4. In one embodiment of the present invention, as depicted in FIG. 1C, the validation data V1 and V2 may be generated by the interactive simulation devices 100 and 200 and transmitted via the media devices 400 and 500. In another embodiment of the present invention, the validation data V1 and V2 may be generated by the media devices 400 and 500 respectively instead of the interactive simulation devices 100 and 200. In addition, the media devices 400 and 500 may verify the received validation data V1 and V2 and determine whether to transmit the interaction data D1 and D2 to the interactive simulation devices 100 and 200 according to the verification result.

The interactive simulation devices 100 and 200 may be any device with sensors, actuators and communication module. The media devices 400 and 500 may be any device with capability to access network, receive media data and output media data. For example, each of the media devices 400 and 500 may be communication devices such as a telephone, a video conference device and a smart phone. For another example, each of the media devices 400 and 500 may be a computing with network access such as a desktop computer, a laptop computer, a tablet computer, a multimedia player, a game console, a set-up box and a smart television. The cloud computing resource 300 may be one or a plurality of physical or virtual computing machines such as a server, a server cluster, a data center or a virtual machine.

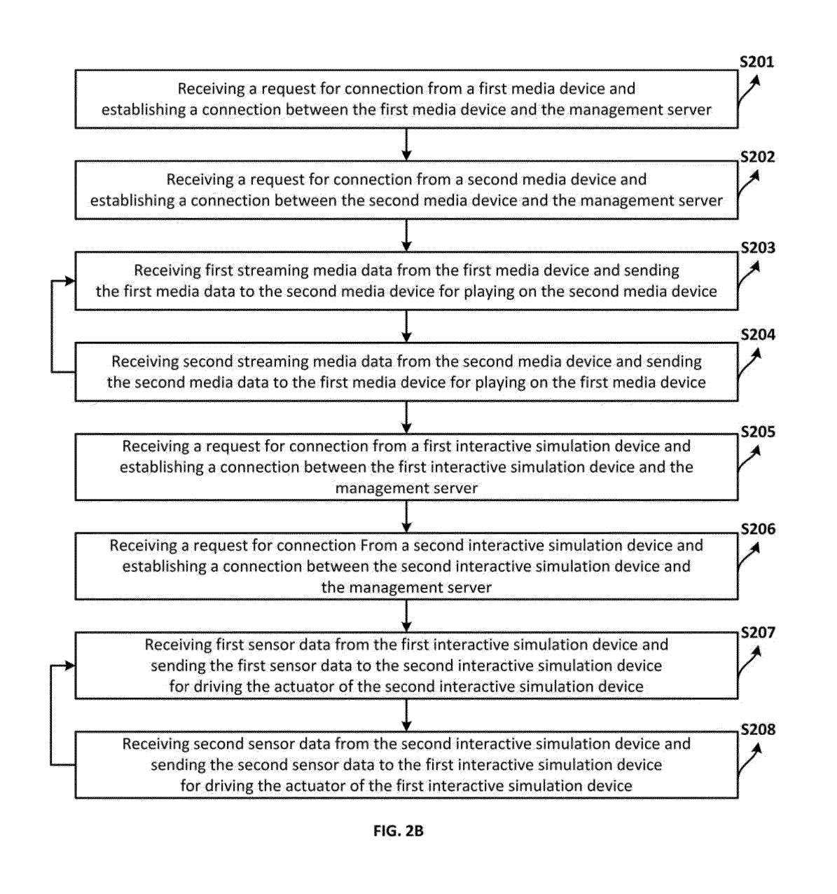

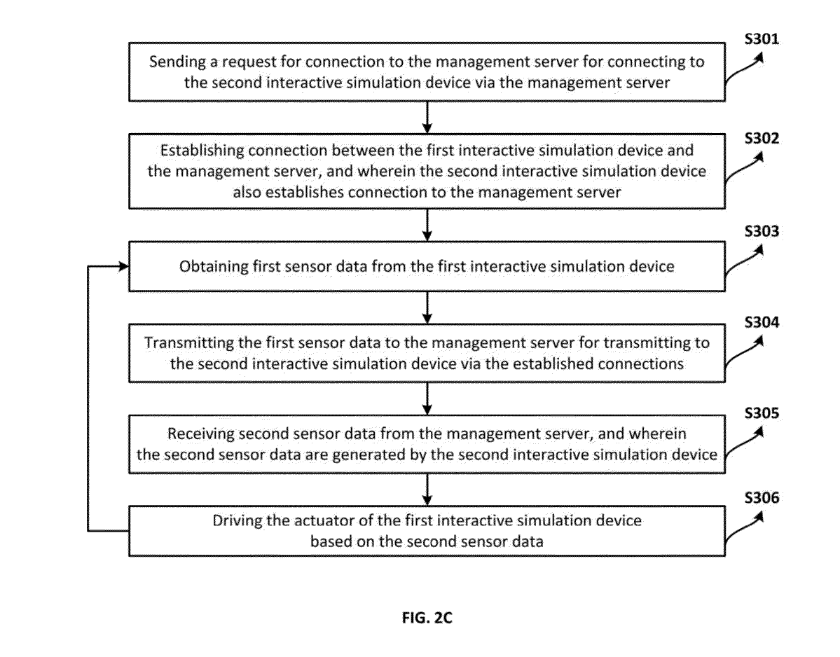

FIGS. 2A to 2C are flowcharts illustrating the method for simulating interaction by using the interactive simulation devices and the media devices according to one embodiment of the present invention. The method of the present invention may be applied on the system comprising interactive simulation devices and media devices, a management server and an interactive simulation device respectively.

FIG. 2A illustrates the method for simulating interaction by using the interactive simulation devices and the media devices according to one embodiment of the present invention. The first media device 400 and the first interactive simulation device 100 may be operated by a user, and the second media device 500 and the second interactive simulation device 200 may be operated by another user. The users may be at different locations. The devices may all have capability to access the management server 310, and the method of present invention may perform the following steps. In step S101, the first media device 400 may send a request for connecting to the management server 310 and establish a connection to the management server 310 when the management server 310 accepts the request. In step S102, the second media device 500 may also send a request for connecting to the management server 310 and establish a connection to the management server 310 when the management server 310 accepts the request. In one embodiment of the present invention, both the first media device 400 and the second media device 500 may have to log in the management server 310 before establishing connections to the management server 310. More specifically, the user of the media devices 400 and 500 may have to log in the management server 310 by entering their user IDs respectively. In step S103, the first media device 400 may obtain first media data from the environment by the operation of its user and transmit to the second media device 500 via the established connections. Also, in step S104, the second media device 500 may obtain second media data from the environment by the operation of its user and transmit to the first media device 400 via the established connections. Each of the first media device 400 and the second media device 500 may output the received media data to their user respectively, and therefore, the users of the media devices 400 and 500 may communication with each other by the repeat media data exchange between the media devices 400 and 500. In step S105, the first interactive simulation device 100 may send a request for connecting to the management server 310 and establish a connection to the management server 310 when the management server accepts the request. In step S106, the second interactive simulation device 200 may also send a request for connecting to the management server 310 and establish a connection to the management server 310 when the management server 310 accepts the request. In one embodiment of the present invention, both the first interactive simulation device 100 and the second interactive simulation device 200 may have to log in the management server 310 before establishing connections to the management server 310. More specifically, the interactive simulation devices 100 and 200 may have to log in the management server 310 with their device IDs or device addresses respectively. In step S107, the first interactive simulation device 100 may obtain first sensor data related to its user from the environment and transmit the first sensor data to the second interactive simulation device 200 via the established connections. In step S108, the second interactive simulation device 200 may receive the first sensor data from the first interactive simulation device 100 and drive an actuator of the second interactive simulation device 200 base on the first sensor data. In step S109, the second interactive simulation device 200 may obtain first sensor data related to its user from the environment during the actuating of the second interactive simulation device 200 as a feedback to the first sensor data and transmit the second sensor data to the first interactive simulation device 100 via the established connections. In step S110, the first interactive simulation device 100 may receive the second sensor data from the second interactive simulation device 200 and drive an actuator of the first interactive simulation device 100 base on the first sensor data for providing the feedback of the first sensor data to its user. In one embodiment of the present invention, the steps S103, S104 S107, S108, S109 and S110 may be performed simultaneously and repeatedly. As a result, the user of the first media device 400 and the first interactive simulation device 100 and the user of the second media device 500 and the second interactive simulation device 200 may interact with each other through not only the audiovisual communication but also other interactions depending on the types of the sensor and actuator in the interactive simulation device 100 and 200, such as tactile interaction with pressure sensors and motors in the interactive simulation device 100 and 200.

FIG. 2B illustrates the method implemented in the management server 310 for simulating interaction by using the interactive simulation devices 100, 200 and the media devices 400, 500 according to one embodiment of the present invention, and the method of present invention may perform the following steps. In step S201, the management server 310 may receive a request for connection from the first media device 400 and establish a connection between the first media device 100 and the management server 310. In step S202, the management server 310 may receive a request for connection from the second media device 500 and establish a connection between the second media device 500 and the management server 310. In step S203, the management server 310 may receive first streaming media data from the first media device 400 and send the first media data to the second media device 500 for playing on the second media device 500. In step S204, the management server 310 may receive second streaming media data from the second media device 500 and send the second media data to the first media device 400 for playing on the first media device 400. In one embodiment of the present invention, the management server 310 may perform step S203 and S204 repeatedly while performing steps S205 to S208. In step S205, the management server 310 may receive a request for connection from the first interactive simulation device 100 and establish a connection between the first interactive simulation device 100 and the management server 310. In step S206, the management server 310 may receive a request for connection from the second interactive simulation device 200 and establish a connection between the second interactive simulation device 200 and the management server 310. In step S207, the management server 310 may receive first sensor data from the first interactive simulation device 100 and send the first sensor data to the second interactive simulation device 200 for driving an actuator of the second interactive simulation device 200. In step S208, the management server 310 may receive second sensor data from the second interactive simulation device 200 and send the second sensor data to the first interactive simulation device 100 for driving an actuator of the first interactive simulation device 100. In one embodiment of the present invention, the management server 310 may perform step S207 and S208 repeatedly. As a result, the management server 310 may enable to the users of the media devices and the interactive simulation devices to remotely interact with each other by both audiovisual communication and tactile interaction.

FIG. 2C illustrates the method implemented in the first interactive simulation device 100 for simulating interaction according to one embodiment of the present invention, and the method of present invention may perform the following steps. In step S301, the first interactive simulation device 100 may send a request for connection to the management server 310 for connecting to the second interactive simulation device 200 via the management server 310. In step S302, the first interactive simulation device 100 may establish connection between the first interactive simulation device 100 and the management server 310, and wherein the second interactive simulation device 200 also establishes connection to the management server 310. In step S303, the first interactive simulation device 100 may obtain first sensor data from the first interactive simulation device 100 by sensing the environment or the operation on its user. In step S304, the first interactive simulation device 100 may transmit the first sensor data to the management server 310 for transmitting to the second interactive simulation device 200 via the established connections. In step S305, the first interactive simulation device 100 may receive second sensor data from the management server 310, and wherein the second sensor data are generated by the second interactive simulation device 200. In step S306, the first interactive simulation device 100 may drive the actuator of the first interactive simulation device 100 based on the second sensor data. In one embodiment of the present invention, the first interactive simulation device 100 may perform the steps S303 to S305 repeatedly.

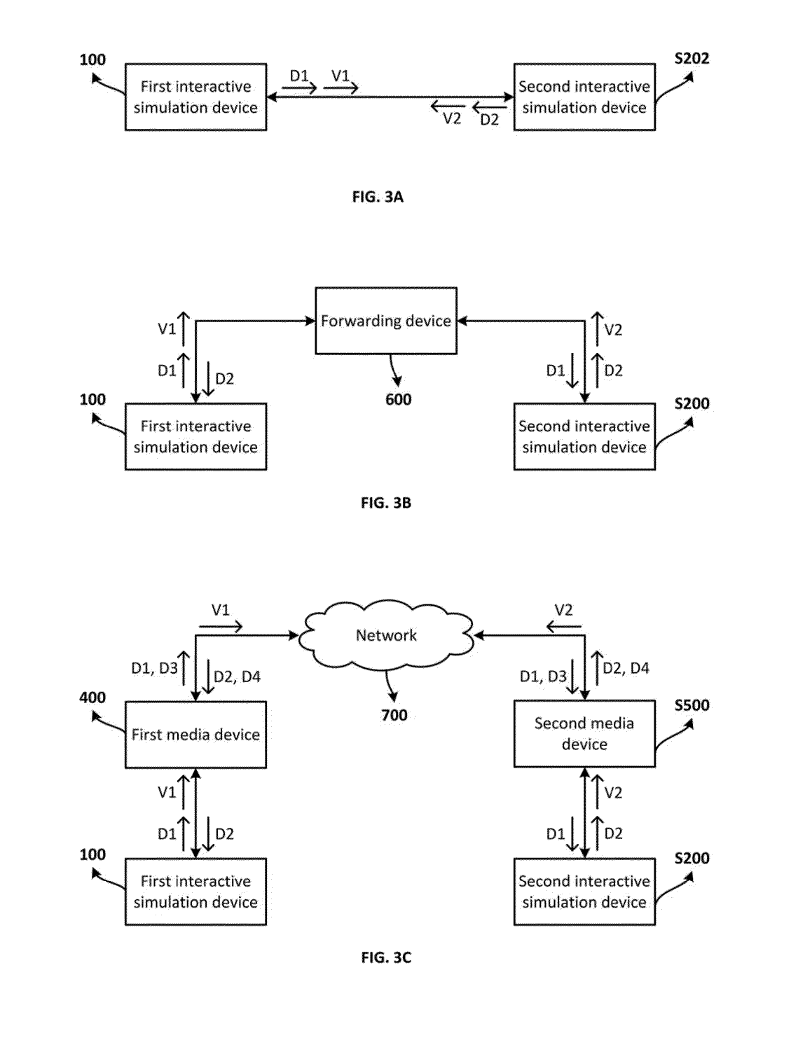

FIG. 3A illustrates a system for simulating interaction comprising the interactive simulation devices according to one embodiment of the present invention.

Referring to FIG. 3A, the system for simulating interaction may comprise a first interactive simulation device 100 and a second interactive simulation device 200. The first interactive simulation device 100 and the second interactive simulation device 200 both may directly communicate with each other via a network system, such as a peer-to-peer network, a virtual private network (VPN) or the telecommunication system. Each of the first interactive simulation device 100 and the second interactive simulation device 200 may generate interaction data D1 and D2 by sensing from the environment, transmit the interaction data D1 and D2 to each other and drive action according to the received interaction data D1 and D2. Therefore, the user of first interactive simulation device 100 may interact with a target object through the system for simulating interaction through the first interactive simulation device. It is noteworthy that the term “target object” may include physical object or virtual object (such as virtual characters or imaginary characters in media content), and the term “object” may also include live beings especially human (denoted as the user of the second interactive simulation device 200). That is, the users of interactive simulation devices 100 and 200 may interact with each of their devices as if they are interacting with each other through the “closed loop” of data exchange between the interactive simulation devices 100 and 200. In one embodiment of the present invention, the validation data V1 and V2 may also be exchanged with interaction data D1 and D2 between the interactive simulation devices 100 and 200 for identifying and validating data received from each other, and wherein the validation data V1, V2 may be recorded within the interactive simulation devices 100 and 200 respectively.

In one embodiment of the present invention, after the second interactive simulation device 200 receives the first validation data V1 and the first interaction data D1 from the first interactive device 100, the second interactive simulation device 200 may actuate according to the first interaction data D1 and send the second interaction data D2 to the first interactive simulation device 100 according to the first validation data V1. The second sexual stimulation device 12 may further verify the first validation data V1, and may actuate according to the first interaction data D1 and send the second interaction data D2 according to the verification result. Similarly, the first interactive simulation device 100 may actuate according to the second interaction D2 and send another interaction data to the second interactive simulation device 200 according to the second validation data V2 after receiving the second validation data V2 and the second interaction D2 from the second interactive simulation device 200 and verifying the second validation data V2.

FIG. 3B illustrates another system for simulating interaction comprising the interactive simulation devices according to one embodiment of the present invention.

Referring to FIG. 3B, the system for simulating interaction may include a first interactive simulation device 100, a second interactive simulation device 200 and a forwarding device 600. The first interactive simulation device 100 and the second interactive simulation device 200 may communicate with the forwarding device 600 for data exchange. The forwarding device 600 may be a router, a gateway, a small cell base station or a game console. Each of the first interactive simulation device 100 and the second interactive simulation device 200 may generate interaction data D1 and D2 by sensing from the environment or the operation of its user, transmit the interaction data D1 and D2 to each other via the forwarding device 600 and drive action according to the received interaction data D1 and D2.

FIG. 3C illustrates another system for simulating interaction comprising the interactive simulation devices according to one embodiment of the present invention. Referring to FIG. 1C, the system for simulating interaction may include the first interactive simulation device 100, the second interactive simulation device 200, the first media device 400 and the second media device 500. The first media device 400 and the second media device 500 may communicate each other through the network 700, such as a peer-to-peer network, a virtual private network, a telecommunication network or the internet. Each of the first media device 400 and the second media device 500 may generate media data D3 and D4 by capturing from the environment, transmit the interaction data D3 and D4 to each other via the network 700 and output the received media data D3 and D4. The first media device 400 and the second media device may further receive interaction data D1 and D2 from the first interactive simulation device 100 and the second interactive simulation device 200 and then transmit the interaction data D1 and D2 to each other. The first media device 400 and the second media device may further transmit the received interaction data D2 and D1 to the first interactive simulation device 100 and the second interactive simulation device 200. Therefore, the interaction data D1 and D2 may be exchanged through the network 700 by the first media device 400 and the second media device 500. In one embodiment of the present invention, the interaction data D1 and D2 may be encoded into the media data D3 and D4 respectively and transmitted to the media devices 400 and 500. The media devices 400 and 500 may retrieve the interaction data D1 and D3 from the received media data D3 and D4 and transmitted to the interactive simulation devices 100 and 200. In one embodiment of the present invention, the media data D3 and D4 may be streaming video and audio data, and wherein the interaction data D1 and D2 may be encoded within the audio data of the media data D3 and D4 respectively especially encoded within audio data corresponding to specific frequency of sound. In addition, one embodiment of the present invention, the interactive simulation devices 100 and 200 each may have a microphone for detecting the sound in the specific frequency to retrieve the interaction data D1 and D2 respectively while the media devices 400 and 500 playing the media data D3 and D4. In one embodiment of the present invention, as depicted in FIG. 3C, the validation data V1 and V2 may be generated by the interactive simulation devices 100 and 200 and transmitted via the media devices 400 and 500. In another embodiment of the present invention, the validation data V1 and V2 may be generated by the media devices 400 and 500 respectively instead of the interactive simulation devices 100 and 200. In addition, the media devices 400 and 500 may verify the received validation data V1 and V2 and determine whether to transmit the interaction data D1 and D2 to the interactive simulation devices 100 and 200 according to the verification result.

In one embodiment of the present invention, the aforementioned media data D3 and D4 may include video data and/or audio data including the video and/or the voice of the user captured by the media devices 400 and 500 respectively. In another embodiment of the present invention, the media data D3 and D4 may include instant messages comprising images and texts inputted by the user. It is comprehensive for the person of ordinary skills to understand that the interaction data D1 and D2 may not have the same type of data. For example, the first interaction data D1 may be motion data for driving a motor in the second interactive simulation device 200 and the second interaction data D2 may be a frequency data for driving a vibrator in the first interactive simulation device 100. Similarly, the interaction data D1 and D2 may not have the same type of data. For example, the first media data D3 may be video data and the second media data D4 may be instant messages comprising texts and images.

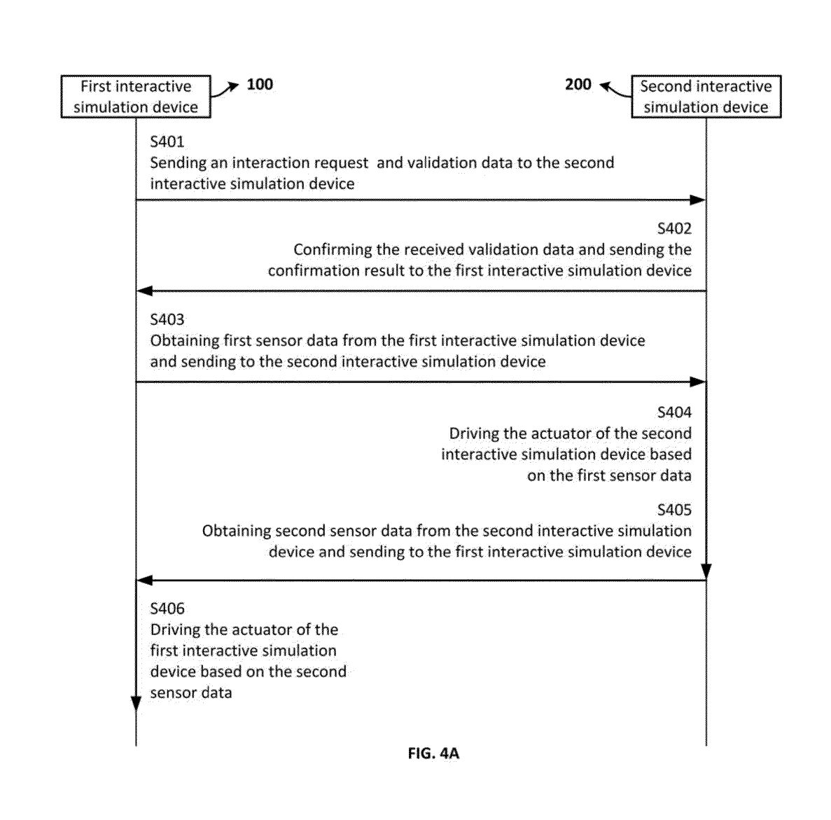

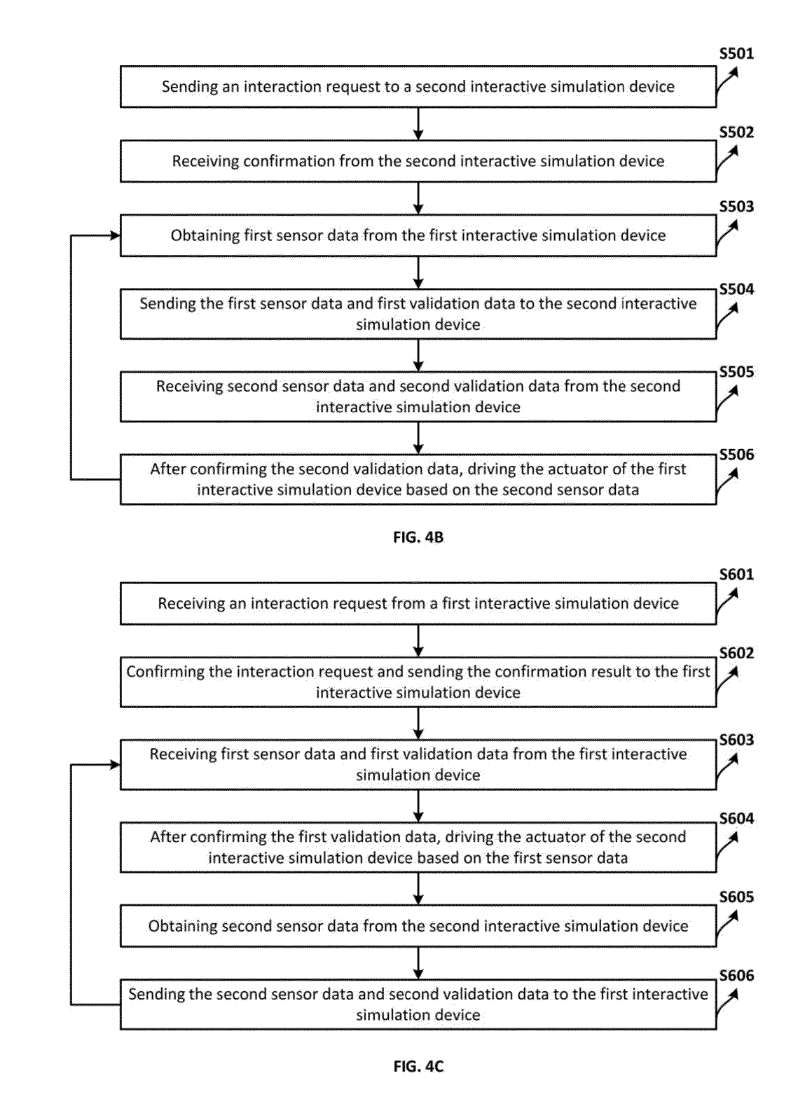

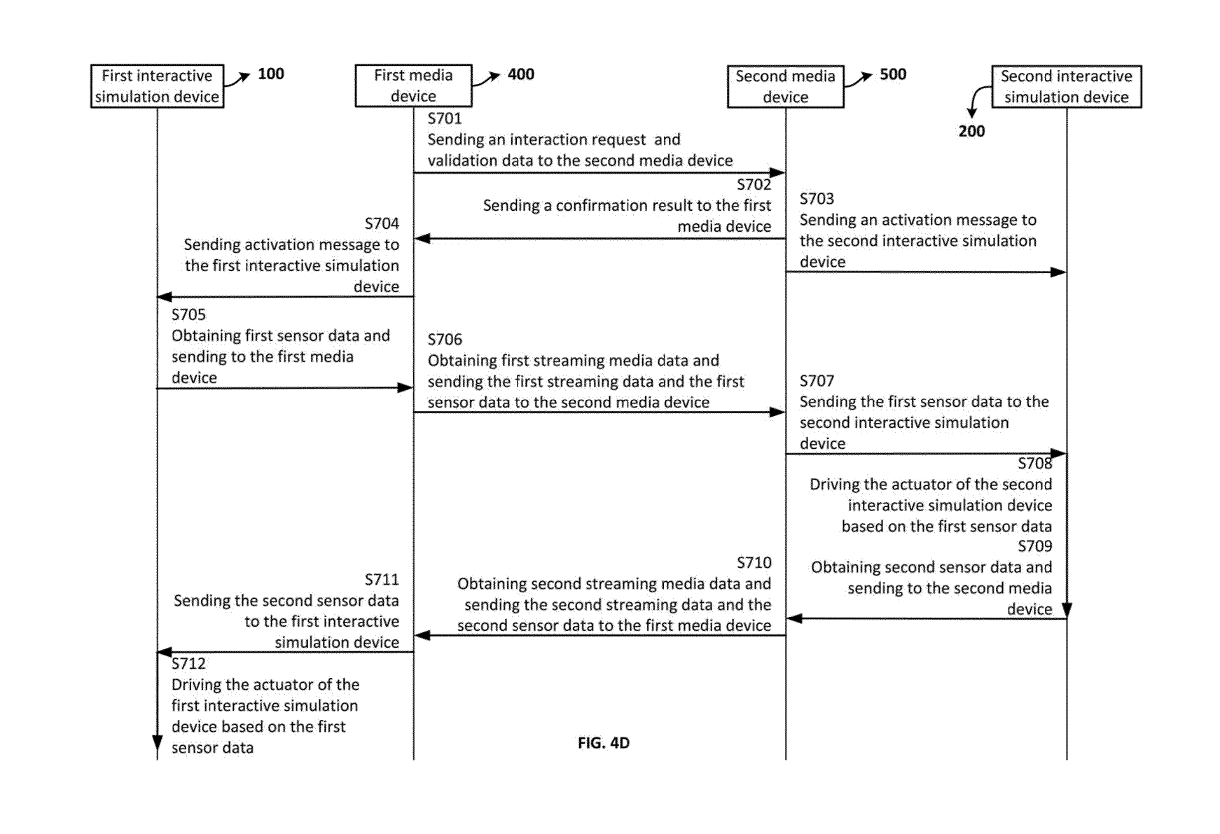

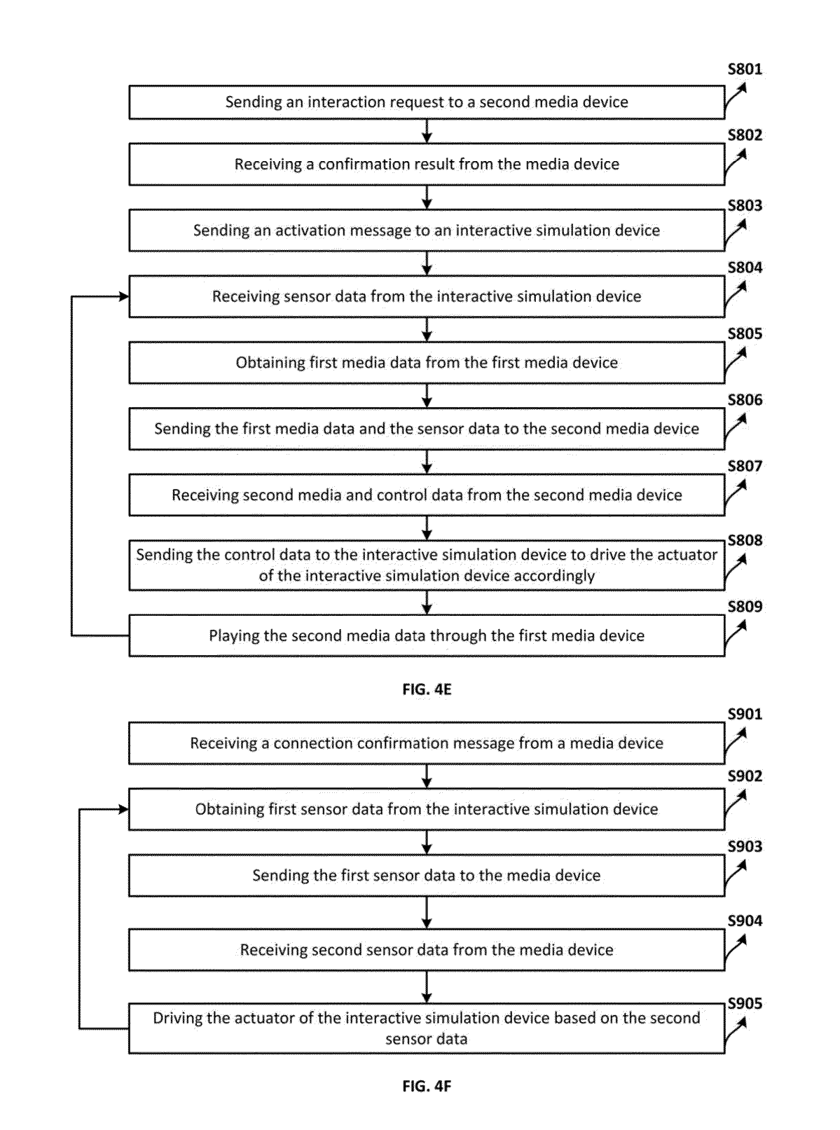

FIGS. 4A to 4C are flowcharts illustrating the method for simulating interaction by using the interactive simulation devices according to another embodiment of the present invention. The method of the present invention may be applied on the system comprising interactive simulation devices and each of the interactive simulation devices respectively.

FIG. 4A illustrates the method for simulating interaction by using the interactive simulation devices according to one embodiment of the present invention, and the method of present invention may perform the following steps. In step S401, the first interactive simulation device 100 may send an interaction request and validation data to the second interactive simulation device. In step S402, the second interactive simulation device 200 may confirm the received validation data and send the confirmation result to the first interactive simulation device 100. In step S403, the first interactive simulation device 100 may obtain first sensor data by sensing the environment and send the first sensor data to the second interactive simulation device 200. In step S404, the second interactive simulation device 200 may drive the actuator of the second interactive simulation device 200 based on the first sensor data. In step S405, the second interactive simulation device 200 may obtain second sensor data by sensing the environment and send the second sensor data to the first interactive simulation device 100. In step S406, the first interactive simulation device 100 may drive the actuator of the first interactive simulation device 100 based on the second sensor data. In one embodiment of the present invention, the first interactive simulation device 100 and the second interactive simulation device 200 may perform the steps S403 to S406 repeatedly.

FIG. 4B illustrates the method implemented in the first interactive simulation device 100 for simulating interaction according to one embodiment of the present invention, and the method of present invention may perform the following steps. In step S501, the first interactive simulation device 100 may send an interaction request to the second interactive simulation device 200. In step S502, the first interactive simulation device 100 may receive confirmation from the second interactive simulation device 200. In step S503, first interactive simulation device 100 may obtain first sensor data by sensing the environment or the operation of its user. In step S504, the first interactive simulation device 100 may send the first sensor data and first validation data to the second interactive simulation device 200. In step S505, the first interactive simulation device 100 may receive second sensor data and second validation data from the second interactive simulation device 200. In step S506, the first interactive simulation device 100 may drive the actuator of itself based on the second sensor data after confirming the second validation data.

FIG. 4C illustrates the method implemented in the second interactive simulation device 200 for simulating interaction according to one embodiment of the present invention, and the method of present invention may perform the following steps. In step S601, the second interactive simulation device 200 may receive an interaction request from the first interactive simulation device 100. In step S602, the second interactive simulation device 200 may confirm the interaction request and send the confirmation result to the first interactive simulation device 100. In step S603, the second interactive simulation device 200 may confirm the interaction request and send the confirmation result to the first interactive simulation device 100. In step S604, the second interactive simulation device 200 may drive its actuator based on the first sensor data after confirming the first validation data. In step S605, the second interactive simulation device 200 may obtain second sensor data by sensing the environment. In step S606, the second interactive simulation device 200 may send the second sensor data and second validation data to the first interactive simulation device 100. In one embodiment of the present invention, the second interactive simulation device 200 may perform the steps S603 to S606 repeatedly.

FIGS. 4D to 4F are flowcharts illustrating the method for simulating interaction by using the interactive simulation devices and media devices according to another embodiment of the present invention. The method of the present invention may be applied in the system comprising interactive simulation devices and media devices, a media device and an interactive simulation device respectively.

FIG. 4D illustrates the method for simulating interaction by using the interactive simulation devices and the media devices according to one embodiment of the present invention. The first media device 400 and the first interactive simulation device 100 may be operated by a user, and the second media device 500 and the second interactive simulation device 200 may be operated by another user. The users may be at different locations. The media devices 400 and 500 may all have capability to communicate with each other by accessing the internet, and the interactive simulation device 100 and 200 may be able to communicate with the media devices 400 and 500 via local area networks. The method of present invention may perform the following steps. In step S701, the first media device 400 may send an interaction request and validation data to the second media device 500. In step S702, the second media device 500 may send a confirmation result to the first media device 400. In step S703, the second media device 500 may send an activation message to the second interactive simulation device 200. In one embodiment of the present invention, the steps S702 and S703 may be performed in a reversed order or at the same time. In step S704, the first media device 400 may send an activation message to the first interactive simulation device 100. In step S705, the first interactive simulation device 100 may obtain first sensor data about the user and send to the first media device 400. In step S706, the first media device 400 may obtain first streaming media data and send the first streaming data and the first sensor data to the second media device 500. In step S707, the second media device 500 may send the first sensor data to the second interactive simulation device 500. In step S708, the second interactive simulation device 200 may drive its actuator based on the first sensor data. In step S709, the second interactive simulation device 200 may obtain second sensor data and send to the second media device 500. In step S710, the second media device 500 may obtain second streaming media data and send the second streaming data and the second sensor data to the first media device 400. In step S711, the first media device 400 may send the second sensor data to the first interactive simulation device 100. In step S712, the first interactive simulation device 100 may drive its actuator based on the first sensor data. In one embodiment of the present invention, the steps S705 to S712 may be performed simultaneously and repeatedly. As a result, the user of the first media device 400 and the first interactive simulation device 100 and the user of the second media device 500 and the second interactive simulation device 200 may interact with each other through not only the audiovisual communication but also other interactions with various types of the sensor and actuator in the interactive simulation device 100 and 200, such as tactile interaction with pressure sensors, air pumps and motors.

FIG. 4E illustrates the method implemented in the first media device 400 for simulating interaction according to one embodiment of the present invention, and the method of present invention may perform the following steps. In step S801, the first media device 400 may send an interaction request to the second media device 500. In step S802, the first media device 400 may send an interaction request to the second media device 500. In step S803, the first media device 400 may send an activation message to the first interactive simulation device 100. In step S804, the first media device 400 may receive sensor data from the first interactive simulation device 100. In step S805, the first media device 400 may obtain first media data by capturing media data related to its user. In step S806, the first media device 400 may send the first media data and the sensor data to the second media device 500. In step S807, the first media device 400 may receive second media and control data from the second media device 500. In step S808, the first media device 400 may receive second media and control data from the second media device 500. In step S809, the first media device 400 may output the second media data for playing. In one embodiment of the present invention, the first media device 400 may perform the steps S804 to S809 repeatedly.

FIG. 4F illustrates the method implemented in the first interactive simulation device 100 for simulating interaction according to one embodiment of the present invention, and the method of present invention may perform the following steps. In step S901, the first interactive simulation device 100 may receive a connection confirmation message from the first media device 400. In step S902, the first interactive simulation device 100 may obtain first sensor data by sensing the environment. In step S903, the first interactive simulation device 100 may send the first sensor data to the first media device 400. In step S904, the first interactive simulation device 100 may receive second sensor data from the first media device 400. In step S905, the first interactive simulation device 100 may drive the actuator of itself based on the second sensor data. In one embodiment of the present invention, the first interactive simulation device 100 may perform the steps S902 to S905 repeatedly.

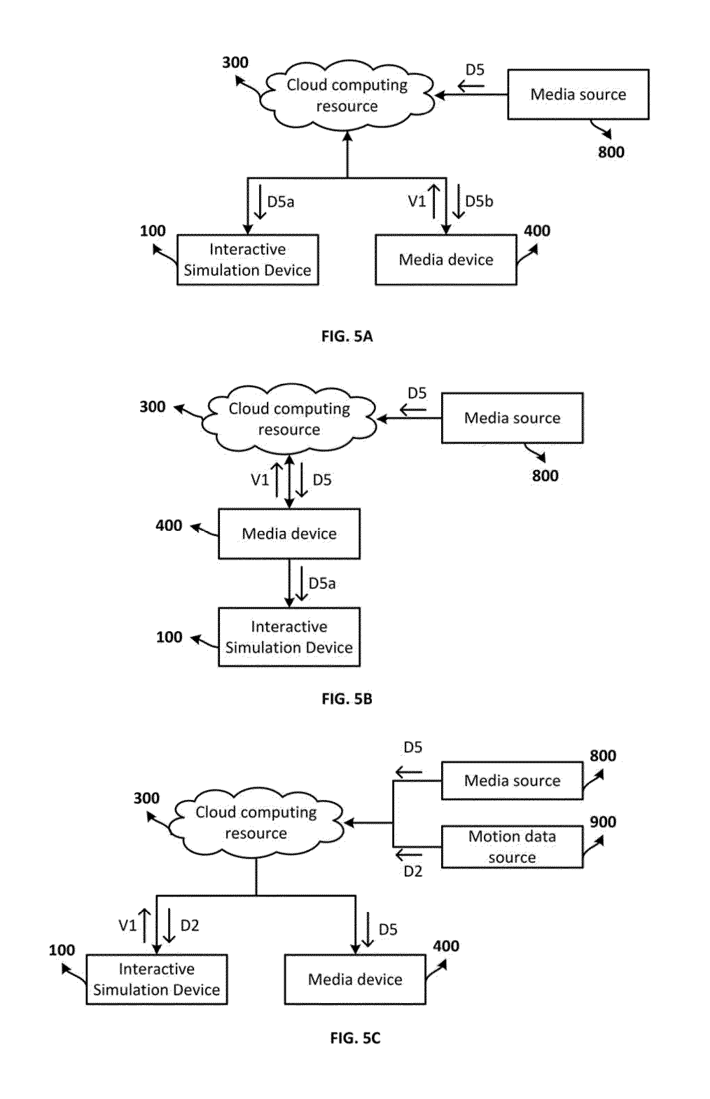

FIGS. 5A to 5C illustrate systems for providing simulated interaction to the interactive simulation devices according to embodiments of the present invention.

Referring to FIG. 5A, the system for providing simulated interaction may comprise a cloud computing resource 300 and a media source 800. An interactive simulation device 100 and a media device 400 may both operated by a user and capable of communicating with the cloud computing resource 300. The media device 400 may send a request for media content D5 to the cloud computing resource 300. The cloud computing resource 300 may retrieve media content D5 from the media source 800 according to the request. The media content D5 may comprise both media data D5b and motion data D5a for driving the interactive simulation device to perform actions, and the cloud computing resource 300 may transmit the media data D5b to the media device 400 and the motion data D5a to the interactive simulation device 100. The media device 400 may output the media data D5b and the interactive simulation device 100 may perform actions according to the motion data D5a. As a result, a simulated experience of interaction with a target object related to the media content D5 as a service in the cloud computing resource 300 may be provided to the user of the interactive simulation device 100 and the media device 400. It is noteworthy that the term “target object” may include physical object or virtual object (such as virtual characters or imaginary characters in media content), and the term “object” may also include live beings especially human. In one embodiment of the present invention, the media device 400 may further transmit validation data V1 to the cloud computing resource 300. The cloud computing resource 300 may then verify the validation data V1 before retrieving media content D5 for response. In another embodiment of the present invention, the media content D5 may be provided to both the interactive simulation device 100 and the media device 400, and the interactive simulation device 100 and the media device 400 may retrieve the motion data D5a and the media data D5b may be retrieved from the media content D5 by the interactive simulation device 100 and the media device 400 respectively.

Referring to FIG. 5B, the system for providing simulated interaction may comprise the cloud computing resource 300 and the media source 800. An interactive simulation device 100 and a media device 400 may both operated by a user. The media device 400 may be capable of communicating with the cloud computing resource 300, and the interactive simulation device 100 may be capable of communicating with the media device 400. The media device 400 may send a request for media content D5 to the cloud computing resource 300. The cloud computing resource 300 may retrieve media content D5 from the media source 800 according to the request and transmit the media content D5 to the media device 400. In one embodiment of the present invention, the media content D5 may be a film containing video and audio data, and wherein the motion data D5b may be encoded within the audio data of the media content D5 especially encoded within audio data corresponding to specific frequency of sound. In addition, one embodiment of the present invention, the interactive simulation device 100 may have a microphone for detecting the sound in the specific frequency to retrieve the motion data D5b while the media device 400 playing the media content D5. In one embodiment of the present invention, the media device 400 may further transmit validation data V1 to the cloud computing resource 300. The cloud computing resource 300 may then verify the validation data V1 before retrieving media content D5 for response. The media device 400 may retrieve motion data D5a from the media content and transmit to the interactive simulation device 100. The media device 400 may output the media content D5, and the interactive simulation device 100 may perform actions according to the motion data D5a. As a result, a simulated experience of interaction with a target object related to the media content D5 may be provided to the user of the interactive simulation device 100 and the media device 400. It is noteworthy that the term “target object” may include physical object or virtual object (such as virtual characters or imaginary characters in media content), and the term “object” may also include live beings especially human.

Referring to FIG. 5C, the system for providing simulated interaction may include a cloud computing resource 300, a media source 800 and a motion data source 900. An interactive simulation device 100 and a media device 400 may both operated by a user and capable of communicating with the cloud computing resource 300. The media device 400 may send a request for media content D5 to the cloud computing resource 300, and the media device may send a request for motion data D2 to the cloud computing device 300. The cloud computing resource 300 may retrieve the media content D5 from the media source 800 and the motion data D2 from the motion data source 900 according to the requests. In one embodiment of the present invention, the media device 400 may further transmit validation data V1 to the cloud computing resource 300. The cloud computing resource 300 may then verify the validation data V1 before retrieving media content D5 and the motion data D2 for response. The media device 400 may output the media content D5 and the interactive simulation device 100 may perform actions according to the motion data D2. As a result, a simulated experience of interaction with a target object related to the media content D5 as a service in the cloud computing resource 300 may be provided to the user of the interactive simulation device 100 and the media device 400. It is noteworthy that the term “target object” may include physical object or virtual object (such as virtual characters or imaginary characters in media content), and the term “object” may also include live beings especially human.

In one embodiment of the present invention, the media source 800 and motion data source 900 may communicate with the media device 400 and the interactive simulation device 100 directly. The media source 800 may be a media server storing media contents and an application program interfaces (API) for communicating with the motion data source 900. While the media content D5 accessed by the user at the media device 400, the media source 800 may receive instructions from the media device 400 requesting the interactive simulation device 100 to perform motions. The media source 800 may request the motion data source 900 for the motion data D2 by calling the API. The motion data source 900 may transmit the motion data D2 to the interactive simulation device 100. For example, the motion data source 900 may find out the interactive simulation device 100 and its address from a database according to user information received from the media source 800. The motion data source 900 may find out the motion data D2 corresponding to the media content D5 according to media content information and playing progress of the media content received from the media source 800. Therefore, the motion data source 900 may transmit motion data D2 corresponding to the current playing media content D5 to the interactive simulation device 100.

In one embodiment of the present invention, the media source 800 and motion data source 900 may communicate with the media device 400 and the interactive simulation device 100 directly. The media source 800 may be able to communicate with the motion data source 900. The media source 800 may receive a request for connection and build a connection with the media device 400. The media source 800 may then send a web page to the media device 400. The media device 400 may login the media source 800 by providing account information and password of its user. The media source 800 may provide a list of media contents to the media device 400 and an API for guiding the user to input the information about the interactive simulation device 100 and sending the information to the motion data source 900. In one embodiment of the present invention, the API may prompt the user to input the ID, password and the type of the interactive simulation device 100. In another embodiment of the present invention, the aforementioned information may be recorded in the interactive simulation device 100. The API may collect the aforementioned information by enabling data transmission between the interactive simulation device 100 and the media device 400. The media source 800 may receive a request for specific media content from the media device 400 and send the media content to the media device 400. The media source 800 may further inform the information of the media content to the motion data source 900 for the motion data source 900 to provide corresponding motion data to the interactive simulation device 100.

In one embodiment of the present invention, motion data may be generated according to media content by performing the following steps of: finding a motion feature in the media content and generating an instruction for an interactive simulation device to perform corresponding motion according to the motion feature. By repeating the aforementioned steps, the instruction may be collected as the motion data corresponding to the media content. The steps may be performed by the media source 800, the motion data source 900, the cloud computing resource 300 or even the media device 400 in real-time or beforehand. The motion data may be stored as a separate file, or embedded into the media content by encoding the motion data into the video data, the audio data or the text data of the media content. For example, the motion data may be encoded as audio data of the media content corresponding to sound signal in specific frequency such as 20 k-22 k KHz. The encoded sound may be mixed with the original audio of the media content. In one embodiment of the invention, the aforementioned steps may be implemented as an application program capable of executed by a computer for performing the steps. User may operate the computer to execute the application program for generating motion data for interactive simulation devices from media contents. The computer may also transmit the motion data to the interactive simulation devices once the instruction for the interactive simulation device to perform corresponding motion to a motion feature in the media content is generated.

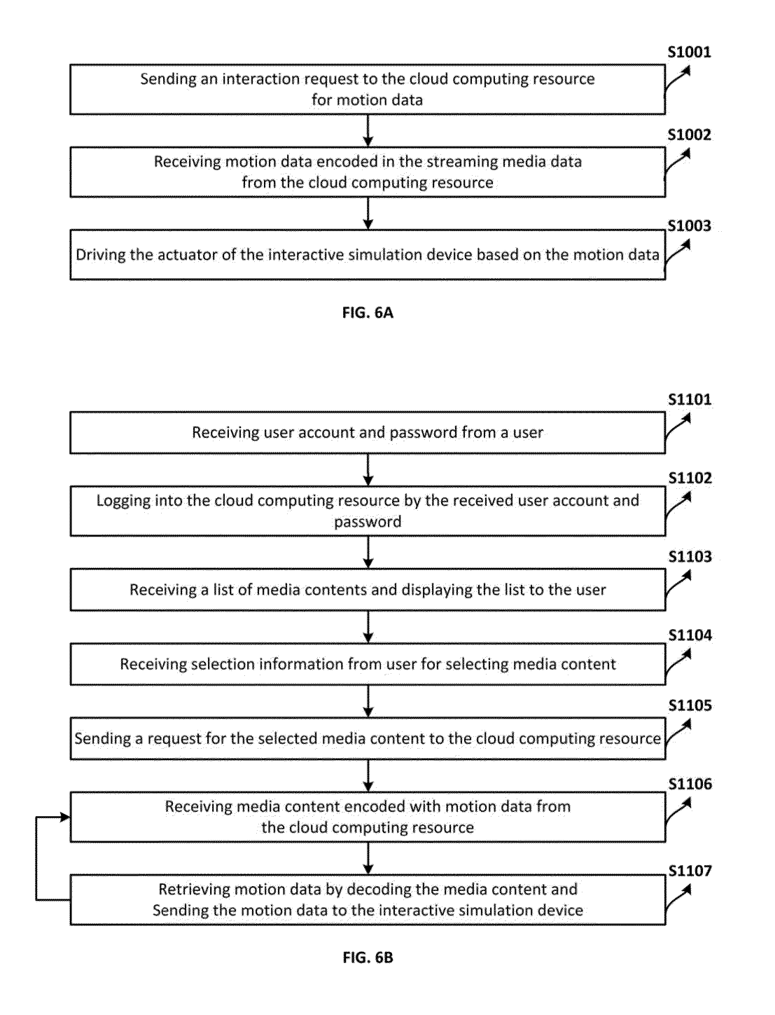

FIGS. 6A and 6B are flowcharts illustrating the method for providing simulated interaction according to another embodiment of the present invention. The method of the present invention may be applied in the interactive simulation devices 100 and the cloud computing resource 300 respectively.

FIG. 6A illustrates the method implemented in the interactive simulation device 100 for providing simulated interaction according to one embodiment of the present invention, and the method of present invention may perform the following steps. In step S1001, the interactive simulation device 100 may send an interaction request to the cloud computing resource 300 for motion data. In step S1002, the interactive simulation device 100 may receive motion data encoded in the streaming media data from the cloud computing resource 300. In step S1003, the interactive simulation device 100 may drive the actuator of itself based on the motion data. In one embodiment of the present invention, the interactive simulation device 100 may perform the steps S1002 and S1003 repeatedly.

FIG. 6B illustrates the method implemented in the media device 400 for providing simulated interaction according to one embodiment of the present invention, and the method of present invention may perform the following steps. In step S1101, the media device 400 may receive a user account and a password from a user. In step S1102, the media device 400 may log in the cloud computing resource 300 by the transmitting the user account and the password to the cloud computing resource 300. In step S1103, the media device 400 may receive a list of media contents and display the list to the user. In step S1104, the media device 400 may receive selection information from the user for selecting media content. In step S1105, the media device 400 may send a request for the selected media content to the cloud computing resource 300. In step S1106, the media device 400 may receive the requested media content encoded with motion data from the cloud computing resource 300. In step S1107, the media device 400 may retrieve motion data by decoding the media content and send the motion data to the interactive simulation device 100. The media device 400 may further display the media content to the user. In one embodiment of the present invention, the media device 400 may perform the steps S1106 and S1107 repeatedly.

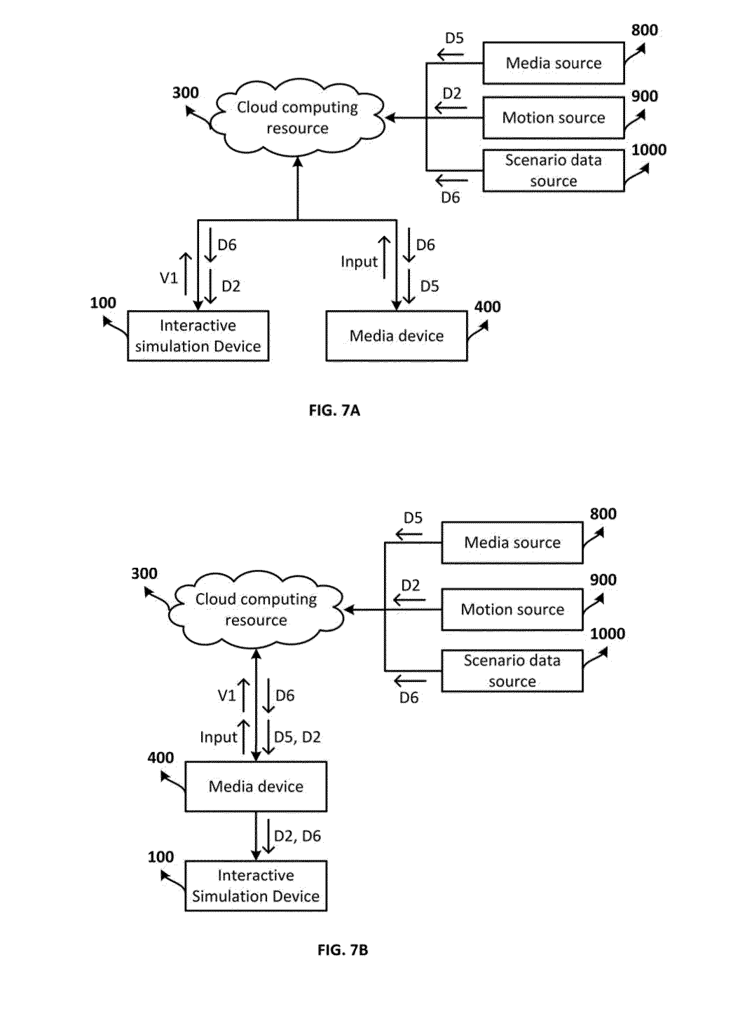

FIGS. 7A and 7B illustrate systems for providing interactive simulation to the interactive simulation device and media device according to embodiments of the present invention.

Referring to FIG. 7A, the system for providing simulated interaction may comprise a cloud computing resource 300, a media source 800, a motion data source 900 and a scenario data source 1000. The scenario data may be media data or motion data provided according to the demand of users. In other words, the scenario data may be on demand data for providing experience of interaction in a specific scenario, such as the background of media content and motion in specific pattern. An interactive simulation device 100 and a media device 400 may both operated by a user and capable of communicating with the cloud computing resource 300. The media device 400 may send a request for media content D5 to the cloud computing resource 300. The cloud computing resource 300 may retrieve media content D5 from the media source 800 and the motion data D2 related to the media content D5 according to the request. The cloud computing resource 300 may transmit the media content 5D to the media device 400 and the motion data D2 to the interactive simulation device 100. The media device 400 may output the media content D5b and the interactive simulation device 100 may perform actions according to the motion data D2. In addition, the media device 400 or the interactive simulation device 100 may receive a command for requesting scenario data from the user. The media device 400 or the interactive simulation device 100 may transmit the request to the cloud computing source 300. The cloud computing source 300 may retrieve scenario data D6 form the scenario data source 1000 and transmit to the media device 400 or the interactive simulation device 100. As a result, a simulated experience of interaction related to the media content D5 with an on-demand scenario as a service in the cloud computing resource 300 may be provided to the user of the interactive simulation device 100 and the media device 400. In one embodiment of the present invention, the media device 400 may further transmit validation data V1 to the cloud computing resource 300. The cloud computing resource 300 may then verify the validation data V1 before retrieving the media content D5, the motion data D2 and the scenario data D6 for response.

Referring to FIG. 7B, the system for providing simulated interaction may comprise a cloud computing resource 300, a media source 800, a motion data source 900 and a scenario data source 1000. An interactive simulation device 100 and a media device 400 may both operated by a user. The media device 400 may be capable of communicating with the cloud computing resource 300, and the interactive simulation device 100 may be capable of communication with the media device 400. The media device 400 may send a request for media content D5 to the cloud computing resource 300. The cloud computing resource 300 may retrieve media content D5 from the media source 800 and the motion data D2 related to the media content D5 according to the request. The cloud computing resource 300 may transmit the media content 5D and the motion data D2 to the media device 400, and the media device 400 may transmit the motion data D2 to the interactive simulation device. The media device 400 may output the media content D5 and the interactive simulation device 100 may perform actions according to the motion data D2. In addition, the media device 400 may receive a command for requesting scenario data from the user. The media device 400 may transmit the request to the cloud computing source 300. The cloud computing source 300 may retrieve scenario data D6 form the scenario data source 1000 and transmit to the media device 400. If the scenario data D6 is related to motion instead of media, the media device 400 may further transmit scenario data D6 to the interaction simulation device 100. As a result, a simulated experience of interaction related to the media content D5 with an on-demand scenario as a service in the cloud computing resource 300 may be provided to the user of the interactive simulation device 100 and the media device 400. In one embodiment of the present invention, the media device 400 may further transmit validation data V1 to the cloud computing resource 300. The cloud computing resource 300 may then verify the validation data V1 before retrieving the media content D5, the motion data D2 and the scenario data D6 for response.

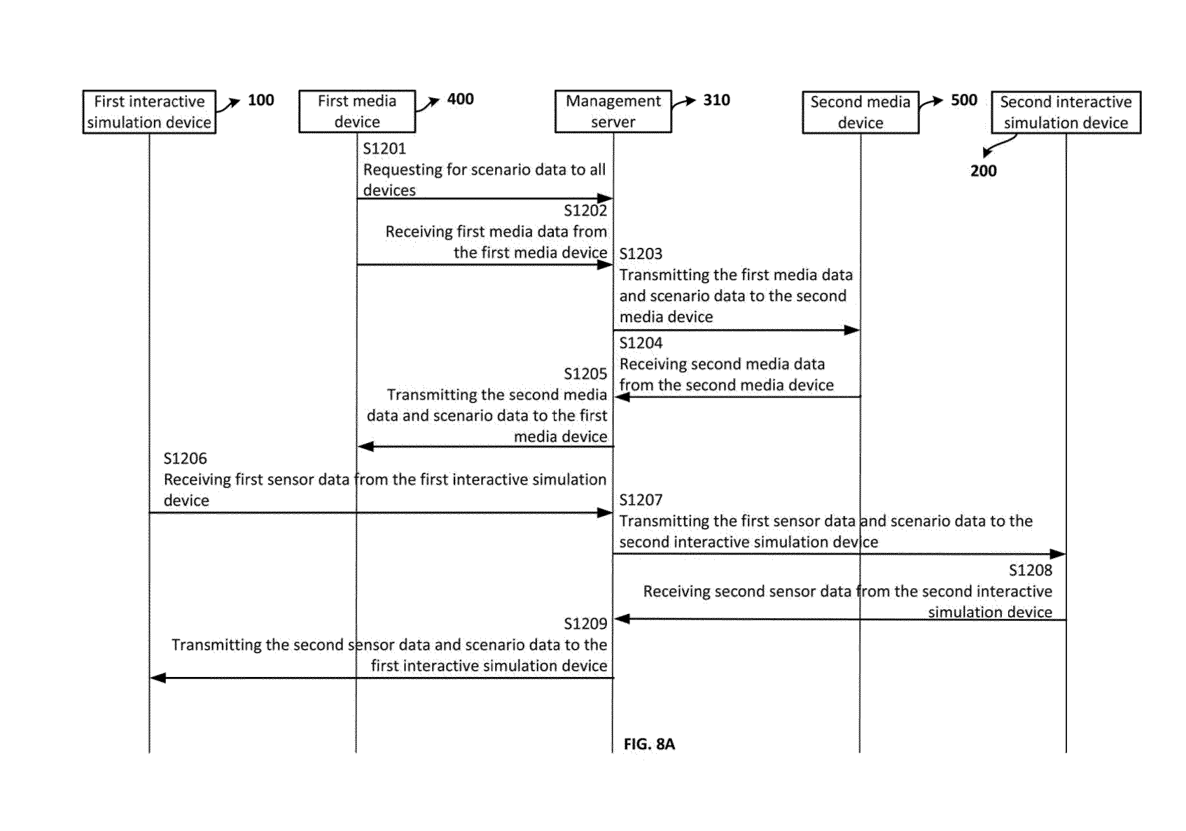

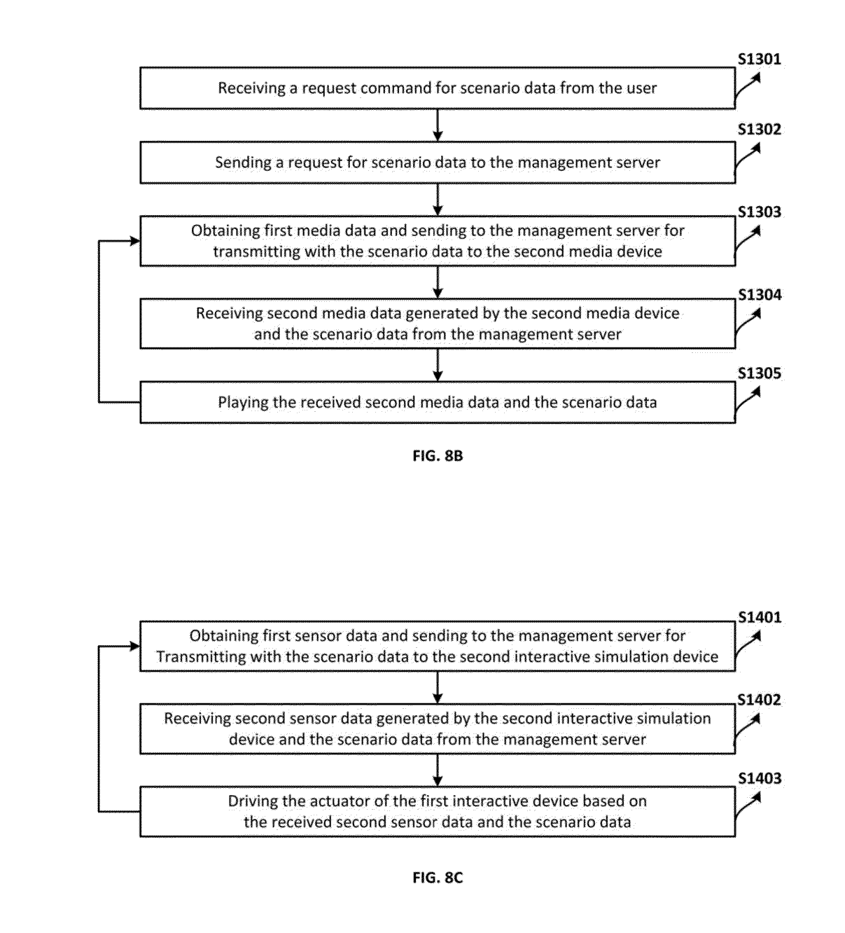

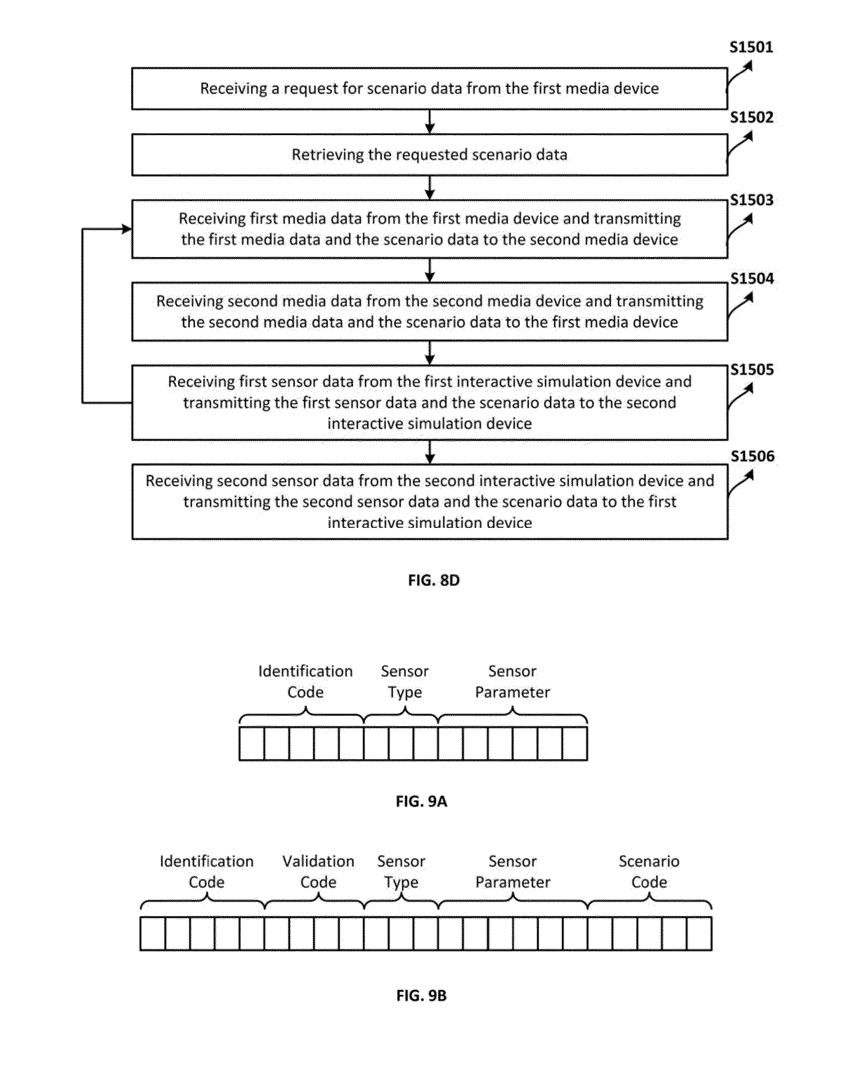

FIGS. 8A to 8D are flowcharts illustrating the method for providing simulated interaction according to another embodiment of the present invention. The method of the present invention may be applied in the first media device 400, the first interactive simulation data 100 and the management server 310 respectively.

FIG. 8A illustrates the method for providing simulated interaction according to one embodiment of the present invention. The first media device 400 and the first interactive simulation device 100 may be operated by a user, and the second media device 500 and the second interactive simulation device 200 may be operated by another user at a different location. The method may be performed during the interaction between the users, and the method of present invention may perform the following steps. In step S1201, the first media device 400 may send a request for scenario data for all devices 100, 200, 400 and 500 to the management server 310. In step S1202, the management server 310 may receive first media data from the first media device 400. In step S1203, management server 310 may transmit the first media data and the requested scenario data to the second media device 500. In step S1204, the management server 310 may receive second media data from the second media device 500. The media devices 400 and 500 may further output the received media data and the scenario data to the user. In step S1205, the management server 310 may transmit the second media data and scenario data to the first media device 400. In step S1206, the management server 310 may receive first sensor data from the first interactive simulation device 100. In step S1207, the management server 310 may transmit the first sensor data and scenario data to the second interactive simulation device 200. In step S1208, the management server 310 may receive second sensor data from the second interactive simulation device 200. In step S1209, the management server 310 may transmit the second sensor data and scenario data to the first interactive simulation device 100. The interactive simulation devices 100 and 200 may further perform actions to their users according to the received sensor data and the scenario data.

FIG. 8B illustrates the method implemented in the first media device 400 for providing simulated interaction according to one embodiment of the present invention, and the method of present invention may perform the following steps. In step S1301, the first media device 400 may receive a request command for scenario data from the user. In step S1302, the first media device 400 may send a request for scenario data to the management server 310. In step S1303, the first media device 400 may obtain first media data and send to the management server 310 for transmitting with the scenario data to the second media device 500. In step S1304, the first media device 400 may receive second media data generated by the second media device 500 and the scenario data from the management server 310. In step S1305, the first media device 400 may play the received second media data and the scenario data to the user.

FIG. 8C illustrates the method implemented in the first interactive simulation device 100 for providing simulated interaction according to one embodiment of the present invention, and the method of present invention may perform the following steps. In step S1401, the first interactive simulation device 100 may obtain first sensor data and send to the management server 310 for transmit with the scenario data to the second interactive simulation device 200. In step S1402, the first interactive simulation device 100 may receive second sensor data generated by the second interactive simulation device 200 and the scenario data from the management server 310. In step S1403, the first interactive simulation device 100 may drive the actuator of itself based on the received second sensor data and the scenario data. In one embodiment of the present invention, the first interactive simulation device 100 may repeat the steps S1401 to S1403.

FIG. 8D illustrates the method implemented in the management sever 310 for providing simulated interaction according to one embodiment of the present invention, and the method of present invention may perform the following steps. In step S1501, the management server 310 may receive a request for scenario data from the first media device 400. In step S1502, the management server 310 may retrieve the requested scenario data. In step S1503, management server 310 may receive first media data from the first media device 400 and transmit the first media data and the scenario data to the second media device 500. In step S1504, the management server 310 may receive second media data from the second media device 500 and transmit the second media data and the scenario data to the first media device 400. In step S1505, the management server may receive first sensor data from the first interactive simulation device 100 and transmit the first sensor data and the scenario data to the second interactive simulation device 200. In step S1506, the management server 310 may receive second sensor data from the second interactive simulation device 200 and transmitting the second sensor data and the scenario data to the first interactive simulation device 100.

FIGS. 9A and 9B illustrate the interaction data exchanged between the interactive simulation devices according to one embodiment of the present invention.

Referring to FIG. 9A, the interaction data may comprise an identification code, a sensor type code and a sensor parameter code. The identification code represents the identification of the interactive simulation device. The sensor type code and the sensor parameter code represent the sensor data obtained by the interactive simulation device. Referring to FIG. 9B, the interaction data may further comprise a validation code and a scenario code. The validation code may help the interactive simulation device to verify the integrity of the interaction data. The scenario code may be preserved to the scenario data provided to the interactive simulation device.

In one embodiment of the present invention, the interaction may be a string comprising a plurality of characters and symbols. In another embodiment of the present invention, the interactive data may be packaged in a specific format, such as JavaScript Object Notation (JSON), Extensible Messaging and Presence Protocol (XMPP) . . . etc. In addition, the interaction data may further be encrypted by RC4. The encryption key may be a user ID or a password. While an interactive simulation device logging in a cloud computing device, the format of the login data in JSON may be illustrated as below:

“UserID”: “Abo@zz.com”,

“DeviceName”: “Abo”

In another embodiment of the present invention, while the cloud computing resource answering the interactive simulation device with a checking result, the result data may be also packaged in the format of JSON and encrypted by RC4. The format of the checking result of JSON may illustrated as below:

“UserID”: “abo@zz.com”,

“DeviceName”: “Abo”,

“Type”: “Login”,

“Value”: “Success”

In another embodiment of the present invention, while the interactive simulation device sensing a parameter with its sensor, the sensor data may be also packaged in the format of JSON and encrypted by RC4. The format of the checking result of JSON may illustrated as below:

“UserID”: “Abo@zz.com”,

“DeviceName”: “Abo”,

“Type”: “MyData”,

“Value”: “120”

In another embodiment of the present invention, while the interactive simulation device obtaining sensor data of another interactive simulation device from the cloud computing resource, the sensor data may be also packaged in the format of JSON and encrypted by RC4. The format of the checking result of JSON may illustrated as below:

“UserID”: “alan@winzz.com”,

“DeviceName”: “Alan”,

“Type”: “PartnerData”,

“Value”: “100”

In another embodiment of the present invention, the interaction data may be packaged in the format of XMPP for exchanging with instant message software installed in media devices. Each of the media devices may pair with an interactive simulation device and transmit the interaction data to the interactive simulation device for performing actions according to the interaction data to the user.

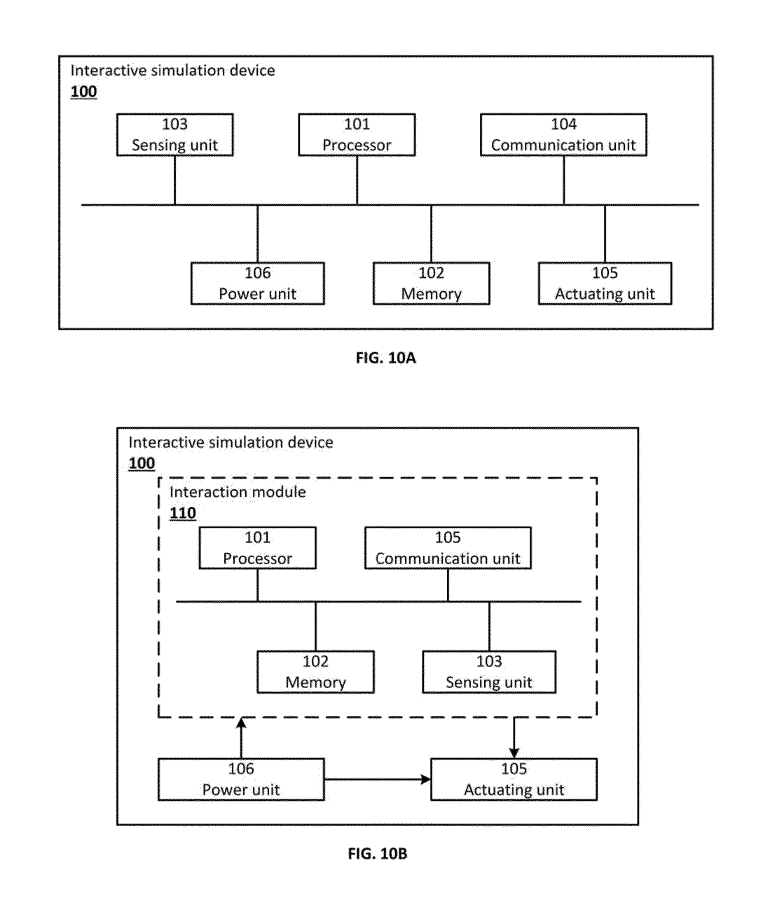

FIGS. 10A and 10B are block diagrams of the interactive simulation device according to one embodiment of the present invention.

Referring to FIG. 10A, the interactive simulation device 100 of the present invention may include a processor 101, a memory 102 for storing or buffering interaction data, a sensing unit 103 for sensing a user's operation to the interactive simulation device 100, a communication unit 104 for receiving interaction data, an actuating unit 105 for performing actions to the user according to the interaction data stored or buffered in the memory 102 and a power unit 106 for supplying energy to other units. The processor 101 may be electrically connected with the memory 102, the sensing unit 103 and the communication unit 104. The communication unit 104 may access a network and receive interaction data from the network. The memory 102 may buffer the interaction data for the actuating unit 105 to perform actions to the user according to the interaction data. The interactive simulation device 100 may cooperate with a media device to provide a more realistic scenario to the user of the devices. The media device receives media content and plays the media content to the user, and at the same time, the interactive simulation device 100 may receive interaction data related to the media content in time sequence and perform actions to the user according to the interaction data. In one embodiment of the present invention, the sensing unit 104 may sense the user's feedback to the actions of the actuating unit 105 for the communication unit 104 to send back. The data exchange with the source of the interaction data may repeat and form a “closed loop” of data flow to provide stimulation to the user and sense the feedback of the user. Therefore, the interactive simulation device 100 may provide an experience of interaction (“simulated interaction) to its user.

Referring to FIG. 10B, the processer 101, the memory 102, the sensing unit 103 and the communication unit 105 may be integrated into an interaction module 110. Interaction data may be received by the interaction module 110 to drive the actuating unit 105. Also, the user's feedback to the actuating unit 105 may be sensed and send back by the interaction module 110. With the interaction module 110, existing devices with a power unit and an actuating unit may act like the interactive simulation device 110.

The processor 101 of the present invention may be a processor or a controller for executing the program instruction in the memory 102 which may be SRAM, DRAM, EPROM, EEPROM, flash memory or other types of computer memory. The processor 110 may further include an embedded system or an application specific integrated circuit (ASIC) having embedded program instructions. The communication unit 105 may be an integrated circuit adopting customized protocols or following existing standards or de facto standards with wired or wireless technology such as Ethernet, IEEE 802.11 or IEEE 802.15 series, Bluetooth, NFC or telecommunication standards such as GSM, CDMA2000, TD-SCDMA, WiMAX, LTE-FDD or TD-LTE. In one embodiment of the present invention, the communication unit 105 may further comprise a physical interface for connecting with connectors of wired transmission or an antenna system for wireless transmission.

The sensing unit 103 may be a sensor in various types, such as an encoder, a pressure sensor, an air sensor, an infrared sensor, a MEMS sensor, a touch sensor, a thermometer, a position sensor, a proximity sensor, an acceleration sensor, a velocity sensor, a frequency sensor . . . etc. In one embodiment of the present invention, the sensing unit 103 may further by an integrated sensor combining any of aforementioned sensors with even a micro controlling unit (MCU) to integrate the measured data. The actuating unit 104 may be a pump, a motor, an air valve, a heater, a vibrator or mechanism driven by the aforementioned actuator. In one embodiment of the present invention, the actuating unit 104 may further comprise mechanisms driven by the aforementioned actuators for performing actions. In one embodiment of the present invention, the sensing unit 103 and the actuating unit 104 may be positioned on a mechanism for simulating at least a part of life form with capability of both sense and action. The actuating unit 104 may drive the mechanism to perform actions and the sensing unit 103 may sense the condition of the mechanism as the feedback to the aforementioned actions from the environment. In one embodiment of the present invention, the sensing unit 103 may not be a part of the interactive simulation device 100. Instead, the sensing unit 103 may include at least of the aforementioned sensors for sensing various conditions of the user and a communication module for transmitted to the sensed data to interactive simulation device 100. The interactive simulation device 100 may receive the data by the communication unit 104.

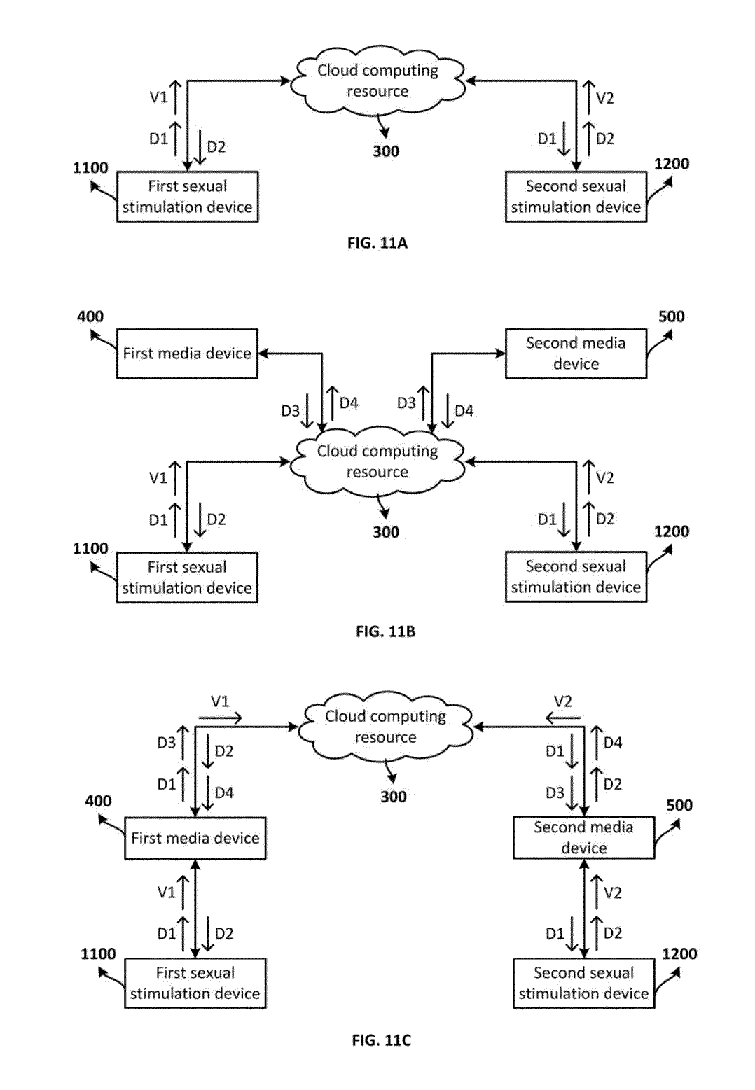

The interactive simulation device of the present invention may simulate various interactions including sexual interaction, especially for sexual stimulation. The following paragraphs accompanying with drawings in FIGS. 11A to 17C describe embodiments of the application for sexual interaction and sexual stimulation of interactive simulation device according to the present invention.

FIG. 11A illustrates a system for sexual interaction comprising the sexual stimulation devices according to one embodiment of the present invention.

Referring to FIG. 11A, the system for sexual interaction may comprise a first sexual stimulation device 1100, a second sexual stimulation device 1200 and a cloud computing resource 300. The first sexual stimulation device 1100 and the second sexual stimulation device 1200 both may communicate with the cloud computing resource 300 for data exchange. Each of the first sexual stimulation device 1100 and the second sexual stimulation device 1200 may generate interaction data D1 and D2 by sensing the body of the user especially the sex organ, transmit the interaction data D1 and D2 to each other via the cloud computing resource 300 and drive actions such as insertion, vibration, heating or squeezing to their user's sex organ according to the received interaction data D1 and D2. Therefore, the users of sexual stimulation devices 1100 and 1200 may simulate sexual interaction with each of their devices as real through the “closed loop” of data exchange between the sexual stimulation devices 1100 and 200. In one embodiment of the present invention, the validation data V1 and V2 may also be exchanged with interaction data D1 and D2 between the sexual stimulation devices 1100 and 1200 for identifying and validating data received from each other.

FIG. 11B illustrates another system for sexual interaction comprising the sexual stimulation devices according to one embodiment of the present invention.

Referring to FIG. 11B, the system for sexual interaction may include a first sexual stimulation device 1100, a second sexual stimulation device 1200, a cloud computing resource 300, a first media device 400 and a second media device 500. The first sexual stimulation device 1100, the second sexual stimulation device 1200, the first media device 400 and the second media device 500 each may communicate with the cloud computing resource 300 for data exchange. Each of the first sexual stimulation device 1100 and the second sexual stimulation device 1200 may generate interaction data D1 and D2 by sensing the body of the user especially the sex organ, transmit the interaction data D1 and D2 to each other via the cloud computing resource 300 and drive action to the body of the user according to the received interaction data D1 and D2. In addition, each of the first media device 400 and the second media device 500 may generate media data D3 and D4 by capturing the voice and/or video of their user, transmit the interaction data D3 and D4 to each other via the cloud computing resource 300 and output the received media data D3 and D4. Therefore, the user of the first media device 400 and the first sexual stimulation devices 1100 and the user of the second media device 500 and the second sexual stimulation device 1200 may simulation interaction with each of their devices as if they are interacting with each other through the “closed loop” of data exchange between the media devices 400, 500 and the sexual stimulation devices 1100, 1200. In one embodiment of the present invention, the aforementioned media data D3 and D4 may include video data and/or audio data including the video and/or the voice of the user captured by the media devices 400 and 500 respectively. In another embodiment of the present invention, the media data D3 and D4 may include instant messages comprising images and texts inputted by the user.

In one embodiment, the media data D3 and D4 each may comprise a streaming data set of a virtual character of the user generated by the cloud computing resource 300 respectively. The first sexual stimulation device 1100 may transmit the first interaction data D1 including the user's motion data to the cloud computing resource 300 for controlling the virtual character, and the cloud computing resource 300 may generate the first media data D3 including the virtual character with motions according to the interaction data. The second media device 500 may receive the media data D3 including the virtual character with motions, and the second sexual stimulation device 1200 may receive the first interaction data D1 for stimulating the user's sex organ at the same time. Similarly, the user of the second media device 500 and the second sexual stimulation device 1200 may send the second interaction data D2 and the second media data D4 including another virtual character with motions corresponding to the second interaction data D2 to the first media device 400 and the first sexual stimulation device 100. Therefore, users of the first media device 400, the first sexual stimulation device 1100 and the second media device 500, the second sexual stimulation device 1200 may simulate sexual interaction with each other through virtual characters in the cyberspace and may feel the motions of each other's virtual character through the sexual stimulation devices 1100 and 1200.

FIG. 11C illustrates another system for sexual interaction comprising the sexual stimulation devices according to one embodiment of the present invention. Referring to FIG. 11C, the system for sexual interaction may include the first sexual stimulation device 1100, the second sexual stimulation device 1200, the cloud computing resource 300, the first media device 400 and the second media device 500. The main difference between the system illustrated in FIG. 11B and FIG. 11C is the interaction data D1 and D2 in FIG. 1C is transmitted to the sexual stimulation devices 1100 and 1200 via the media devices 400 and 500 respectively. In one embodiment of the present invention, the interaction data D1 and D2 may be encoded into the media data D3 and D4 respectively and transmitted to the media devices 400 and 500. The media devices 400 and 500 may retrieve the interaction data D1 and D3 from the received media data D3 and D4 and transmitted to the sexual stimulation devices 1100 and 200. In one embodiment of the present invention, as depicted in FIG. 11C, the validation data V1 and V2 may be generated by the sexual stimulation devices 1100 and 1200 and transmitted via the media devices 400 and 500. In another embodiment of the present invention, the validation data V1 and V2 may be generated by the media devices 400 and 500 respectively instead of the sexual stimulation devices 1100 and 200. In addition, the media devices 400 and 500 may verify the received validation data V1 and V2 and determine whether to transmit the interaction data D1 and D2 to the sexual stimulation devices 1100 and 1200 according to the verification result.

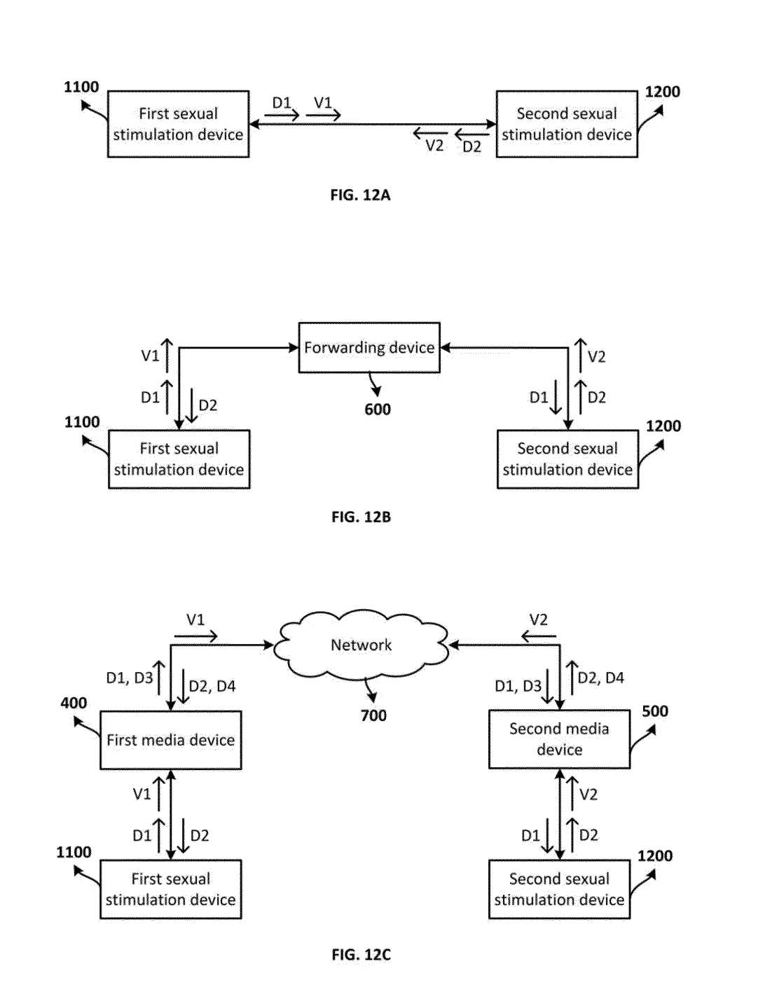

FIG. 12A illustrates a system for sexual interaction comprising the sexual stimulation devices according to one embodiment of the present invention.

Referring to FIG. 12A, the system for sexual interaction may comprise a first sexual stimulation device 1100 and a second sexual stimulation device 1200. The first sexual stimulation device 1100 and the second sexual stimulation device 1200 both may directly communicate with each other via a network system, such as a peer-to-peer network, a virtual private network (VPN) or the telecommunication system. Each of the first sexual stimulation device 1100 and the second sexual stimulation device 1200 may generate interaction data D1 and D2 by sensing from the environment, transmit the interaction data D1 and D2 to each other and perform motion to stimulate their users' sex organs according to the interaction data D1 and D2. Therefore, the users of sexual stimulation devices 1100 and 1200 may simulate sexual interaction with each of their devices as real through the “closed loop” of data exchange between the sexual stimulation devices 1100 and 1200. In one embodiment of the present invention, the validation data V1 and V2 may also be exchanged with interaction data D1 and D2 between the sexual stimulation devices 1100 and 1200 for identifying and validating data received from each other, and wherein the validation data V1, V2 may be recorded within the sexual stimulation devices 1100 and 1200 respectively.

FIG. 12B illustrates another system for sexual interaction comprising the sexual stimulation devices according to one embodiment of the present invention.

Referring to FIG. 12B, the system for sexual interaction may include a first sexual stimulation device 1100, a second sexual stimulation device 1200 and a forwarding device 600. The first sexual stimulation device 1100 and the second sexual stimulation device 1200 may communicate with the forwarding device 600 for data exchange. The forwarding device 600 may be a router, a gateway, a small cell base station or a game console. Each of the first sexual stimulation device 1100 and the second sexual stimulation device 1200 may generate interaction data D1 and D2 by sensing the body of their user especially sex organ, transmit the interaction data D1 and D2 to each other via the forwarding device 600 and drive action according to the received interaction data D1 and D2.

FIG. 12C illustrates another system for sexual interaction comprising the sexual stimulation devices according to one embodiment of the present invention. Referring to FIG. 12C, the system for sexual interaction may include the first sexual stimulation device 1100, the second sexual stimulation device 1200, the first media device 400 and the second media device 500. The first media device 400 and the second media device 500 may communicate each other through the network 700, such as a peer-to-peer network, a virtual private network, a telecommunication network or the internet. Each of the first media device 400 and the second media device 500 may generate media data D3 and D4 by capturing video and/or voice of their user, transmit the interaction data D3 and D4 to each other via the network 700 and present media data D3 and D4 to the users. The first media device 400 and the second media device may further receive interaction data D1 and D2 from the first sexual stimulation device 1100 and the second sexual stimulation device 1200 and then transmit the interaction data D1 and D2 to each other. The first media device 400 and the second media device may further transmit the received interaction data D2 and D1 to the first sexual stimulation device 1100 and the second sexual stimulation device 200. Therefore, the interaction data D1 and D2 may be exchanged through the network 700 by the first media device 400 and the second media device 500. In one embodiment of the present invention, the interaction data D1 and D2 may be encoded into the media data D3 and D4 respectively and transmitted to the media devices 400 and 500. The media devices 400 and 500 may retrieve the interaction data D1 and D3 from the received media data D3 and D4 and transmitted to the sexual stimulation devices 1100 and 1200. In one embodiment of the present invention, as depicted in FIG. 12C, the validation data V1 and V2 may be generated by the sexual stimulation devices 1100 and 1200 and transmitted via the media devices 400 and 500. In another embodiment of the present invention, the validation data V1 and V2 may be generated by the media devices 400 and 500 respectively instead of the sexual stimulation devices 1100 and 1200. In addition, the media devices 400 and 500 may verify the received validation data V1 and V2 and determine whether to transmit the interaction data D1 and D2 to the sexual stimulation devices 1100 and 1200 according to the verification result.

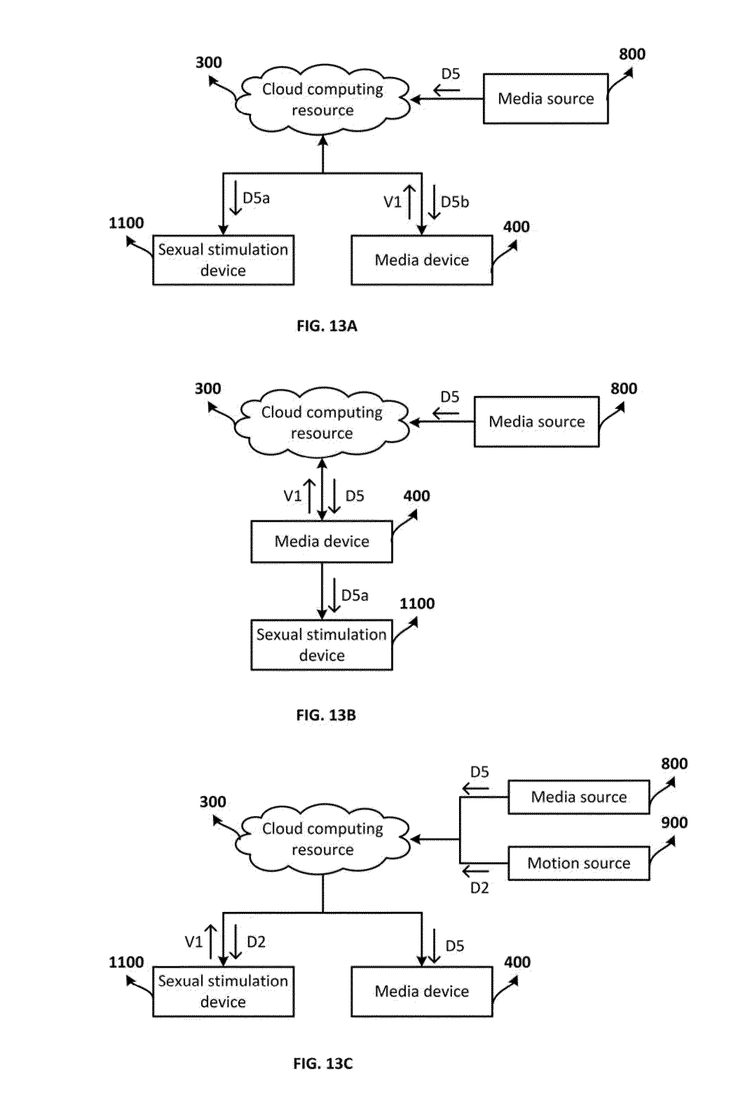

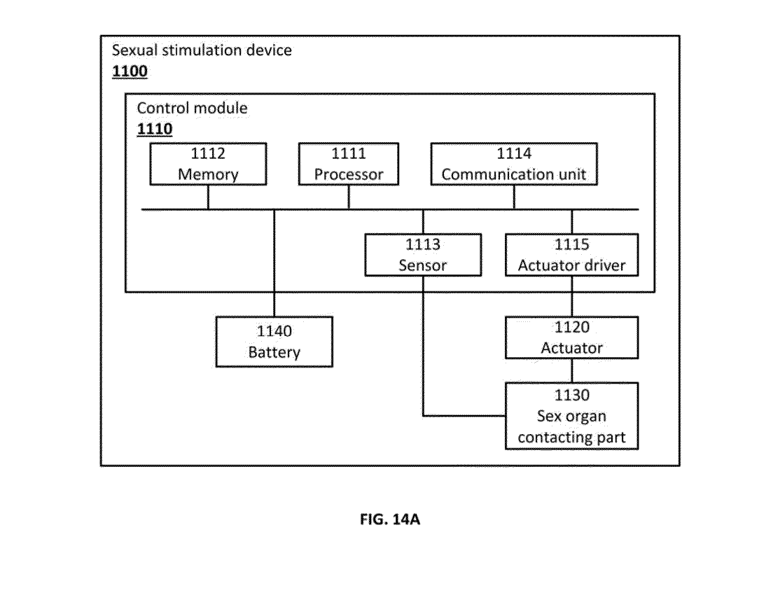

FIGS. 13A to 13C illustrate systems for providing simulated interaction to the sexual stimulation devices according to embodiments of the present invention.

Referring to FIG. 13A, the system for providing simulated interaction may comprise a cloud computing resource 300 and a media source 800. A sexual stimulation device 1100 and a media device 400 may both operated by a user and capable of communicating with the cloud computing resource 300. The media device 400 may send a request for media content D5 such as adult film or adult video conference to the cloud computing resource 300. The cloud computing resource 300 may retrieve media content D5 from the media source 800 according to the request. The media content D5 may comprise both media data D5b and motion data D5a for driving the sexual stimulation device to perform actions, and the cloud computing resource 300 may transmit the media data D5b to the media device 400 and the motion data D5a to the sexual stimulation device 100. The media device 400 may present the media data D5b to the user and the sexual stimulation device 1100 may perform actions to stimulate the sex organ of the user according to the motion data D5a. As a result, a simulated experience of sexual interaction related to the media content D5 as a service in the cloud computing resource 300 may be provided to the user of the sexual stimulation device 1100 and the media device 400. In one embodiment of the present invention, the media device 400 may further transmit validation data V1 to the cloud computing resource 300. The cloud computing resource 300 may then verify the validation data V1 before retrieving media content D5 for response. In another embodiment of the present invention, the media content D5 may be provided to both the sexual stimulation device 100 and the media device 400, and the sexual stimulation device 100 and the media device 400 may retrieve the motion data D5a and the media data D5b may be retrieved from the media content D5 by the sexual stimulation device 100 and the media device 400 respectively.

Referring to FIG. 13B, the system for providing simulated interaction may comprise the cloud computing resource 300 and the media source 800. A sexual stimulation device 1100 and a media device 400 may both operated by a user. The media device 400 may be capable of communicating with the cloud computing resource 300, and the sexual stimulation device 1100 may be capable of communicating with the media device 400. The media device 400 may send a request for media content D5 to the cloud computing resource 300. The cloud computing resource 300 may retrieve media content D5 from the media source 800 according to the request and transmit the media content D5 to the media device 400. In one embodiment of the present invention, the media device 400 may further transmit validation data V1 to the cloud computing resource 300. The cloud computing resource 300 may then verify the validation data V1 before retrieving media content D5 for response. The media device 400 may retrieve motion data D5a from the media content and transmit to the sexual stimulation device 100. The media device 400 may output the media content D5, and the sexual stimulation device 1100 may perform actions to stimulate the sex organ of the user according to the motion data D5a. As a result, a simulated experience of sexual interaction related to the media content D5 may be provided to the user of the sexual stimulation device 1100 and the media device 400.

Referring to FIG. 13C, the system for providing simulated interaction may include a cloud computing resource 300, a media source 800 and a motion data source 900 storing the motion pattern of the sexual stimulation device. A sexual stimulation device 1100 and a media device 400 may both operated by a user and capable of communicating with the cloud computing resource 300. The media device 400 may send a request for media content D5 to the cloud computing resource 300, and the media device may send a request for motion data D2 to the cloud computing device 300. The cloud computing resource 300 may retrieve the media content D5 from the media source 800 and the motion data D2 from the motion data source 900 according to the requests. In one embodiment of the present invention, the media device 400 may further transmit validation data V1 to the cloud computing resource 300. The cloud computing resource 300 may then verify the validation data V1 before retrieving media content D5 and the motion data D2 for response. The media device 400 may output the media content D5 and the sexual stimulation device 1100 may perform actions to stimulate the sex organ of the user according to the motion data D2. As a result, a simulated experience of sexual interaction related to the media content D5 as a service in the cloud computing resource 300 may be provided to the user of the sexual stimulation device 1100 and the media device 400.

In one embodiment of the present invention, motion data may be generated according to media content by performing the following steps of: finding a motion feature in the media content and generating an instruction for a sexual stimulation device to perform corresponding motion according to the motion feature. By repeating the aforementioned steps, the instruction may be collected as the motion data corresponding to the media content. The steps may be performed by the media source 800, the motion data source 900, the cloud computing resource 300 or even the media device 400 in real-time or beforehand. The motion data may be stored as a separate file, or embedded into the media content by encoding the motion data into the video data, the audio data or the text data of the media content. For example, if the media data is an adult film, the actors may perform sexual intercourse with several sex positions in the film such as exclusively penetrative positions, non-exclusively penetrative positions or non-penetrative positions. Exclusively penetrative positions may include penetrating partner on top with front entry, penetrating from behind, receiving partner on top, sitting and kneeling, standing, anal sex positions, less common positions, using furniture or special apparatus, positions to promote or prevent conceptions, positions during pregnancy . . . etc; Non-exclusively penetrative positions may include oral sex positions, cunnilingus, fellatio, sixty-nine, anilingus . . . etc; Non-penetrative positions may include genital-genital rubbing. Different instructions may be generated according to different sex positions for simulating the stimulation to the user's sex organ during sexual interaction with the sex positions. In addition, despite motion features, sound features such as specific frequency of sound, shrill or specific words in the adult film may also be found and the instructions for a sexual stimulation device to perform corresponding motions according to the sound features may also be generated in one embodiment of the present invention.

In one embodiment of the invention, the aforementioned steps may be implemented as an application program capable of executed by a computer for performing the steps. User may operate the computer to execute the application program for generating motion data for interactive simulation devices from media contents. The computer may also transmit the motion data to the interactive simulation devices once the instruction for the interactive simulation device to perform corresponding motion to a motion feature in the media content is generated.

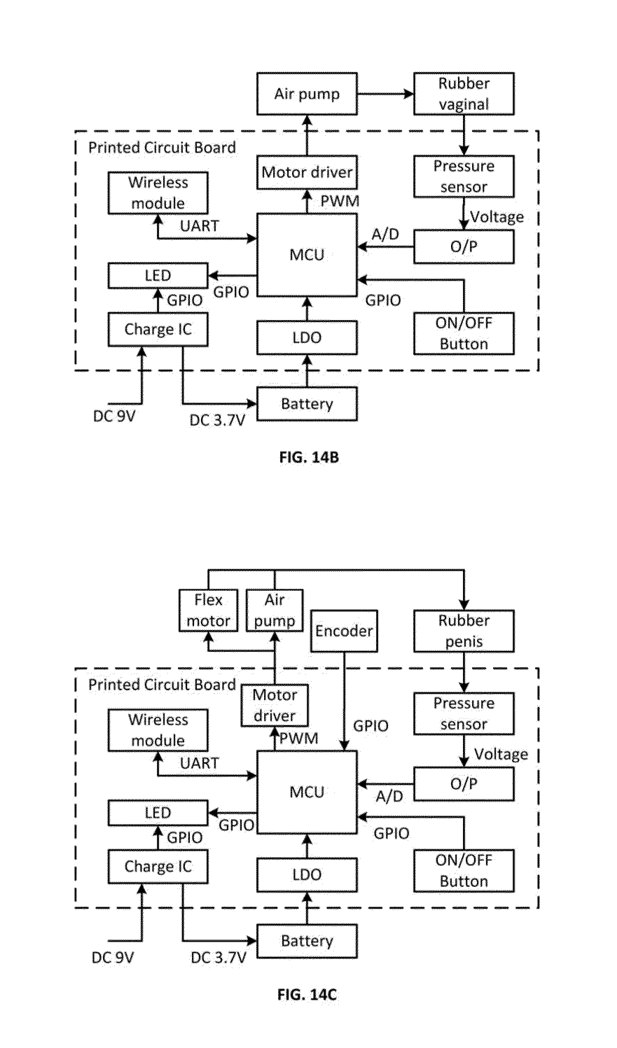

FIGS. 14A to 14C are block diagrams of the sexual stimulation device according to embodiments of the present invention.

Referring to FIG. 14A, the sexual stimulation device 1100 of the present invention may include a control module 1110, an actuator 1120 controlled by the control module 1110, a sex organ contacting part for contacting with the body of the user especially the sex organ and a battery 1140 supplying power to the control module 1110 and the actuator 1130. The control module 1110 may send instructions to the actuator 1120 for driving the sex organ contacting part 1130 to perform various actions to the sex organ of the user, such as insertion or squeezing. The control module 1110 may further comprise a processor 1111, a memory 1112 for storing or buffering interaction data, a sensing unit 1113 for sensing the status of the sex organ contacting part 1130 as the user's feedback to the actions of the sexual stimulation device 1100, a communication unit 104 for receiving interaction data, an actuating driver 1115 for driving the actuator according to the interaction data. The processor 101 may be electrically connected with the memory 102, the sensing unit 103, the communication unit 104 and the actuator driver 1115. The communication unit 104 may access a network and receive interaction data from the network. The memory 102 may buffer the interaction data received by the communication unit 104 for the actuator 1120 driving the sex organ contacting part 1130 according to the interaction data. The sexual stimulation device 1100 may cooperate with a media device to provide a more realistic scenario to the user of the devices. The media device receives media content and plays the media content to the user, and meanwhile, the sexual stimulation device 1100 may receive interaction data related to the media content in time sequence and perform actions to the user according to the interaction data. In one embodiment of the present invention, the sensing unit 104 may sense the user's feedback to the actions performed by the sexual stimulation device 1100 and the communication unit 104 may send sensed data back. The data exchange with the source of the interaction data may repeat and form a “closed loop” of data flow to provide sexual stimulation to the user and sense the feedback of the user. Therefore, the sexual stimulation device 1100 may provide an experience of simulated sexual interaction to its user.

The control module 1110 may comprise a printed circuit board for mounting and integrating the processor 1111, the memory 1112, the sensing unit 1113, the communication unit 1114 and the actuator driver 1115 together. The processor 1111 may be a processor or a controller for executing the program instruction in the memory 1112 which may be SRAM, DRAM, EPROM, EEPROM, flash memory or other types of computer memory. The processor 1111 may further include an embedded system or an application specific integrated circuit (ASIC) having embedded program instructions. The communication unit 1114 may be an integrated circuit adopting customized protocols or following existing standards or de facto standards with wired or wireless technology such as Ethernet, IEEE 802.11 or IEEE 802.15 series, Bluetooth, NFC or telecommunication standards such as GSM, CDMA2000, TD-SCDMA, WiMAX, LTE-FDD or TD-LTE. In one embodiment of the present invention, the communication unit 1114 may further comprise a physical interface for connecting with connectors of wired transmission or an antenna system for wireless transmission. The sensing unit 1113 may be a sensor in various types, such as an encoder, a pressure sensor, an air sensor, an infrared sensor, a MEMS sensor, a touch sensor, a thermometer, a position sensor, a proximity sensor, an acceleration sensor, a velocity sensor, a frequency sensor . . . etc. In one embodiment of the present invention, the sensing unit 1113 may further by an integrated sensor combining any of aforementioned sensors with even a micro controlling unit (MCU) to integrate the measured data. The actuator driver 1115 may be a storing device such as ROM, flash memory installed with instructions to the actuator 1120 corresponding to the interaction data. In one embodiment of the present invention, the sensing unit 1113 may not be a part of the sexual stimulation device 1100. Instead, the sensing unit 11113 may include at least of the aforementioned sensors for sensing various conditions of the user and a communication module for transmitted to the sensed data to sexual stimulation device 1100. The interactive simulation device 100 may receive the data by the communication unit 1114.

The actuator 1120 may be a pump, a motor, an air valve, a heater, a vibrator, a liquid jetting unit for simulating body fluid jet or mechanism driven by the aforementioned actuator. In one embodiment of the present invention, the actuator 1120 may further comprise mechanisms driven by the aforementioned actuators for performing actions. In one embodiment of the present invention, the sensing unit 1113 and the actuator 1120 may be positioned on a mechanism for simulating at least a part of life form with capability of both sense and action. The sex organ contacting part 1130 may be made of non-toxic material for contacting to the user's body. In one embodiment of the present invention, the contacting part 1130 may be made of flexible or elastic material such as rubber or silicone material (polysiloxane). In another embodiment of the present invention, the contacting part 1130 may be made of rigid material such as wood or metal. The sex organ contacting part 1130 may further be in shapes of human body or sex organs for simulating real human being. The actuator 1120 may drive the sex organ contacting part 1130 to perform actions and the sensing unit 1113 may sense the physical conditions of the sex organ contacting part 1130 as the user's feedback to the aforementioned actions.

For example, if the sexual stimulation device is a sex toy simulating the sex organ of a female, the sex organ contacting part 1130 may include at least one air bag and at least one concave-shape elastic body made of silicone, and wherein the air bag may surround the elastic body and be in contact with the elastic body. The actuator 1120 may be a pump for inflating the air bag to cause an inner force to deform the elastic body. For another example, if the sexual stimulation device is a sex toy simulating the sex organ of a male, the sex organ contacting part 1130 may include at least one air bag and at least one rod-shape elastic body made of silicone, and wherein the air bag may be disposed within the elastic body. The actuator 1120 may comprise a pump for inflating the air bag to expanding the elastic body. The actuator 1120 may further comprise a linear motor for moving the airbag of the elastic body for simulating the insertion or the pulling back of a male's sex organ. It is noteworthy that the aforementioned air bag may be replaced by any deformable medium such as a bag with liquid inside. Also, the contacting part 1130 may also be rigid and therefore comprising a rigid body driven by the actuator 1120 such as a motor instead.

FIG. 14B illustrates the sexual stimulation device which simulates the sex organ of a female (vaginal) according to one embodiment of the present invention. The sexual stimulation device may be a sex toy simulating a female sex organ with a rubber vaginal and primary for male. As depicted in FIG. 14B, a wireless module may communicate with a cloud computing resource or another sexual stimulation device for transmitting and receiving interaction data via telecommunication system, wireless local area network (WLAN) or the internet. The received interaction data may contain sensor data or sensor parameters discussed in previous paragraphs. A micro controlling unit (MCU) may control the motor driver by pulse width modulation (PWM) signal based on the received interaction data. Then an air pump may inflate the rubber vaginal to a predetermined pressure or with a predetermined time period. The rubber vaginal may include an airbag and an elastic body made of flexible material such as silicone. The rubber vaginal may be deformed based on pressure contained inside the air bag and the size of the inserted object such as a penis of a user. In addition, the sexual stimulation device may also include an air draining valve connecting to the airbag of the rubber vaginal so that the inflated air may be leaked instead of breaking the airbag. A pressure sensor may sense the pressure of air inside the airbag and generate a corresponding voltage. An operational (OP) amplifier may process the voltage and then output a signal to the MCU. The MCU may generate interaction data based on the sensed pressure and may send the interaction data to the aforementioned cloud computing resource or sexual stimulation device. The sensed pressure may relate to the size or other physical condition of an inserted object (a penis of a user) and a target condition of the rubber vaginal according to the received interaction data. The air pump may inflate the airbag at a certain frequency to a predetermined pressure based on the received interaction data. The air valve may be also controlled by the MCU to drain he pressure based on the received interaction data. In one embodiment of the present invention, the sexual stimulation device may further be turn on/off by a button. The sexual stimulation device may also be powered by a battery or other power source such as DC 9V from a voltage converter.

FIG. 14C illustrates the sexual stimulation device which simulates the sex organ of a male (penis) according to one embodiment of the present invention. The sexual stimulation device may be a sex toy simulating a male sex organ with a rubber vaginal and primary for male. As depicted in FIG. 14C, a wireless module may communicate with a cloud computing resource or another sexual stimulation device for transmitting and receiving interaction data via telecommunication system, wireless local area network (WLAN) or the internet. The received interaction data may contain sensor data or sensor parameters discussed in previous paragraphs. A micro controlling unit (MCU) may control the motor driver by pulse width modulation (PWM) signal based on the received interaction data. A flex motor may be driven by a motor driver so that a rod supporting the rubber penis may stretch out or return back. The position of the rod may be determined by an encoder. The MCU may also control an air pump for inflating the rubber penis. The air pump may inflate the rubber penis to a predetermined pressure or with a predetermined time period. The rubber penis may include an airbag and an elastic body made of flexible material such as silicone. The rubber penis may be deformed based on pressure contained inside the air bag and the size of the inserted object such as a penis of a user. In addition, the sexual stimulation device may also include an air draining valve connecting to the airbag of the rubber penis so that the inflated air may be leaked instead of breaking the airbag. A pressure sensor may sense the pressure of air inside the airbag and generate a corresponding voltage. An operational (OP) amplifier may process the voltage and then output a signal to the MCU. The MCU may generate interaction data based on the sensed pressure and may send the interaction data to the aforementioned cloud computing resource or sexual stimulation device. The sensed pressure may relate to the size or other physical condition of a receiving object (a vaginal of a user) and a target condition of the rubber penis according to the received interaction data. The air pump may inflate the airbag at a certain frequency to a predetermined pressure based on the received interaction data. The air valve may be also controlled by the MCU to drain he pressure based on the received interaction data. In one embodiment of the present invention, the sexual stimulation device may further be turn on/off by a button. The sexual stimulation device may also be powered by a battery or other power source such as DC 9V from a voltage converter.

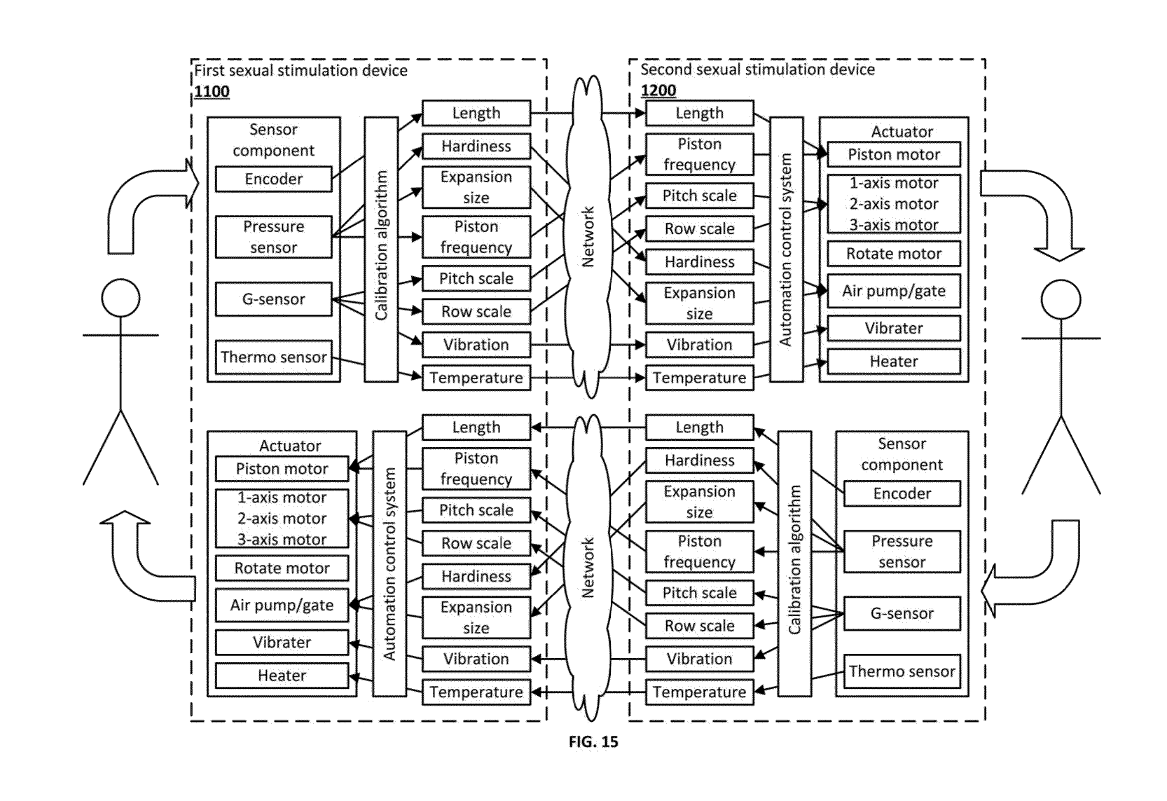

FIG. 15 illustrates the closed-loop data exchange for simulating sexual interaction between the sexual stimulation devices according to another embodiment of the present invention.

Referring to FIG. 15, the first sexual stimulation device 1100 and the second sexual stimulation device 1200 may communicate with each other through a network such as a telecommunication network or the internet for data exchange. Each of the sexual stimulation devices 1100 and 1200 may comprise sensor components such as an encoder, a pressure sensor, a G-sensor, a thermo sensor and other types of sensors for sensing the physical condition of the user's sex organ or the simulated sex organ for contacting with the user's sex organ. The sensor components may generate sensed result. The sensed result may need calibration by calibration algorithm which may be performed by the processor or MCU of the sexual stimulation devices. After calibration, the processor or MCU of the sexual stimulation devices may obtain sensor parameters such as length, hardiness, expansion size, piston frequency, pitch scale, row scale, vibration, temperature and other parameters. The length may be originated from the encoder; the hardness, expansion size and the piston frequency may be originated from the pressure sensor; the pitch scale, the row scale and vibration may be originated from the G-sensor; and the temperature may be originated from the thermo sensor.

The sensor parameters obtained by each of sexual stimulation devices 1100 and 1200 may be transmitted to each other. Each of sexual stimulation devices 1100 and 1200 may receive the sensor parameters by its communication unit. The sensor parameters may be processed by processor or MCU of the sexual stimulation devices which may drive automation control system. After processing, the processor or MCU of the sexual stimulation devices may send signals or instructions to actuators such as a piston motor, an axis motor, a rotate motor, an air pump/air gate, a vibrator, a heater or other actuators. The sexual stimulation devices may be therefore actuated to drive related mechanism. The length and the piston frequency may be fed to the piston motor; the hardness and the expansion size may be fed to the air pump and/or air gate; the pitch scale and the row scale may be fed to the axis motor; the vibration may be fed to the vibrator; the temperature may be fed to the heater; and the rotate motor may be selectively controlled for operation. Therefore, a closed loop of the data flow may be formed by the exchange of the sensor parameters originated from the sensor components sensing the condition of the users and for the actuators performing motion to the users. As a result, a simulated interaction between the users of the sexual stimulation devices 1100 and 1200 may be enabled by the closed loop of data exchange.

In one embodiment of the present invention, a fake interaction may be enabled by generating sensor parameters regardless of the sensed result from the sensor components. For example, the user of the sexual stimulation device 1100 may stop actions due to reasons such as the ejaculation of a male in sexual interaction. However, the sexual stimulation device 1100 may generate fake sensor parameters for its user to pretend continuously performing actions to the sexual stimulation device 1100. In one embodiment of the present invention, the fake sensor parameters may be generated by the sexual stimulation device 1100 and sent to the sexual stimulation device 1200 for the user of the sexual stimulation device 1200 enjoying the interaction. In another embodiment of the present invention, the data exchange may be processed by a cloud computing resource in the network, and the fake sensor parameters may be generated by the cloud computing resource 1100 and sent to the sexual stimulation device 1200 for the user of the stimulation device 1200 enjoying the interaction. Furthermore, in one embodiment of the present invention, the fake sensor parameters may be randomly generated. In another embodiment of the present invention, sensor parameters may be recorded by the sexual stimulation device or the cloud computing resource during one simulated sexual interaction and reused as the fake sensor parameters in another simulated sexual interaction.

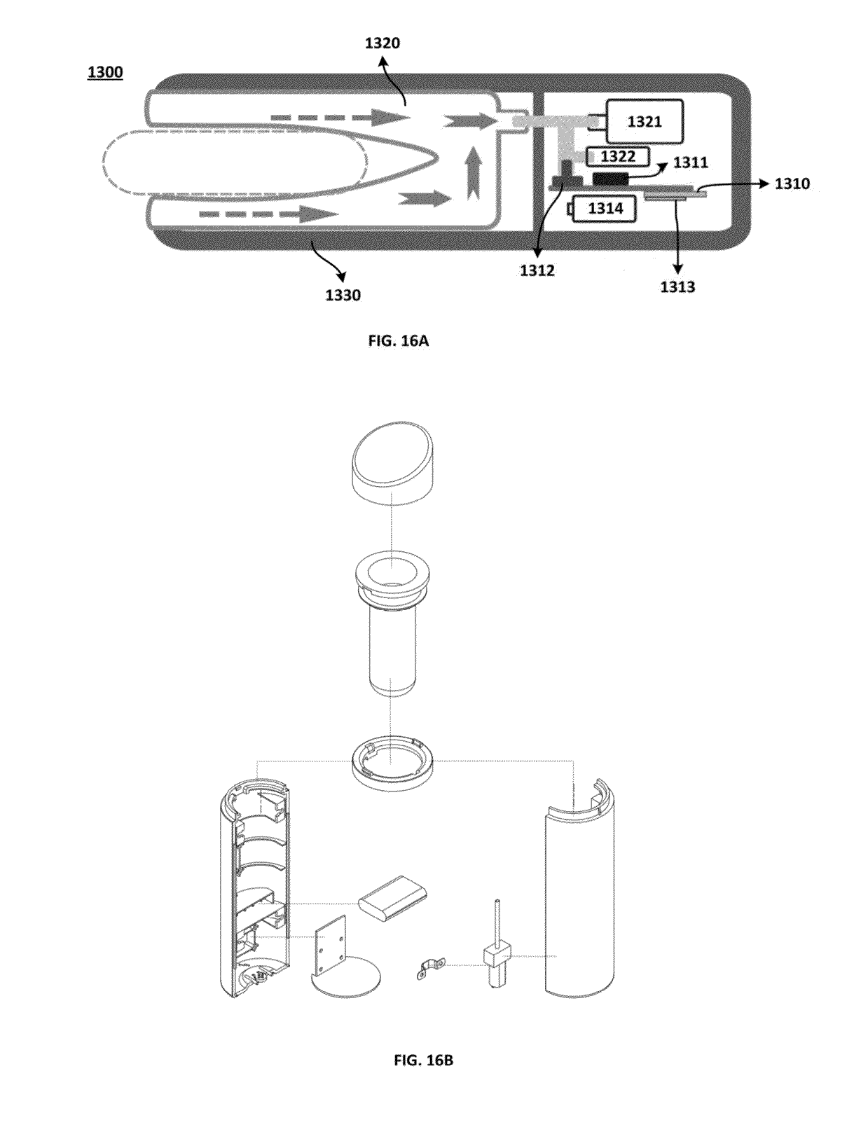

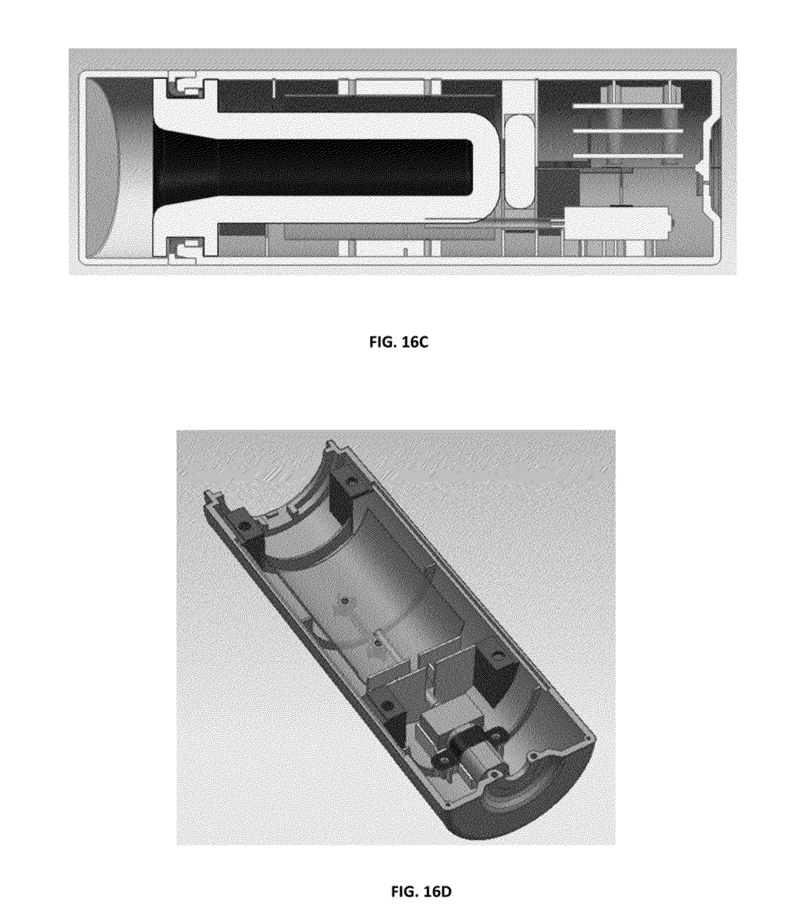

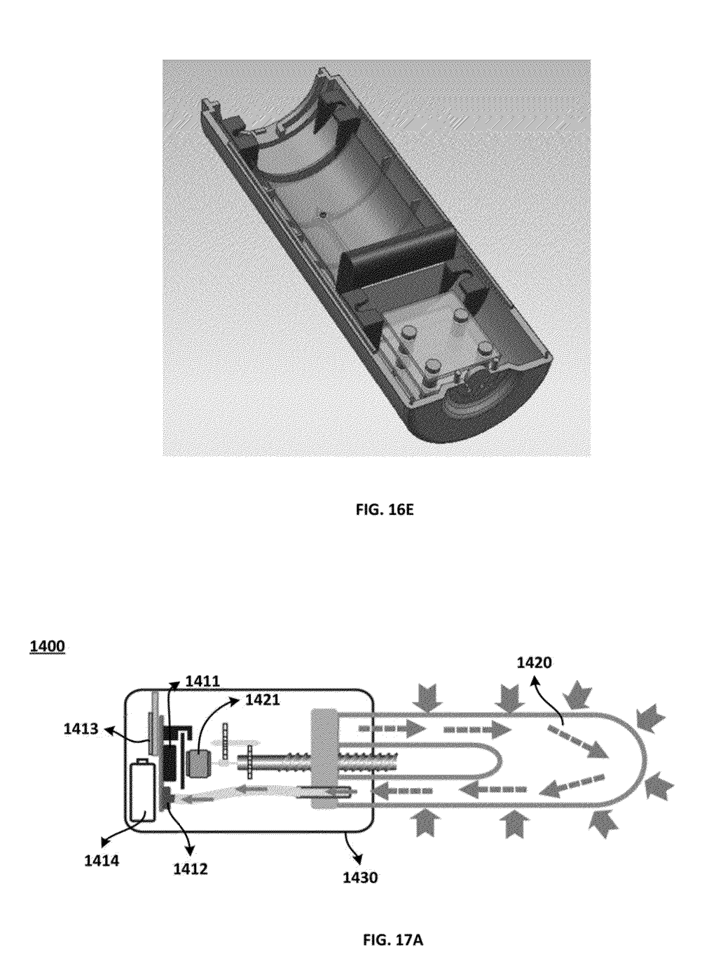

FIGS. 16A, 16B, 16C, 16D and 16E are depicting diagrams of the sexual stimulation device simulating the sex organ of a female according to one embodiment of the present invention. Referring to FIG. 16A, the sexual stimulation device 1300 may be a sex toy simulating the sex organ a female and the sex toy may be usually for male such as a masturbation cup. The sexual stimulation device 1300 may comprise a control module 1310, an actuator 1320 and a case 1330 enclosing the control module 1310 and the actuator 1320. The control module 1310 may comprise a printed circuit board (PCB) mounting a MCU 1311, a pressure sensor 1312, a wireless module 1313 and a battery 1314 connected to the PCB. The actuator 1320 may comprise an air bag enclosing a silicone vaginal generally for the insertion of the user's penis and an air pump 1321, an air valve 1322 connected to the airbag respectively. The air pump 1321 and the air valve 1322 may be controlled by the MCU 1311 for inflating and/or deflating the airbag to deform the silicone vaginal. The pressure sensor 1312 may be positioned in contact with the air inside of the airbag for measurement of the inner pressure of the airbag. Referring to FIG. 16B to 16D, the actuator 1320 may comprise two airbags mount respective to two half cases of the case 1330, and the two airbags may surround the silicone vaginal. The bottom and the printed circuit board of the control module 1310 may be mounted on one of the half cases and the air pump 1321 may be mounted on the other half cases. The battery 1314 may be disposed between the printed circuit board and the airbags. After assembling the half cases together, a ring may be disposed on the top of the two half cases to secure the half cases. The silicone vaginal may be inserted into the case 1330 through the ring and have a groove for fixed with the ring. Lubricous oil may be contained within the groove between the top of the case 1330 and the silicone vaginal. The silicone vaginal may be tightly assembled with the cases to prevent the lubricous oil flowing into the case 1330. A cap may cover the silicone vaginal and the top of the case 1330 for keeping the silicone vaginal in good condition when the sexual stimulation device 1300 is not operated.

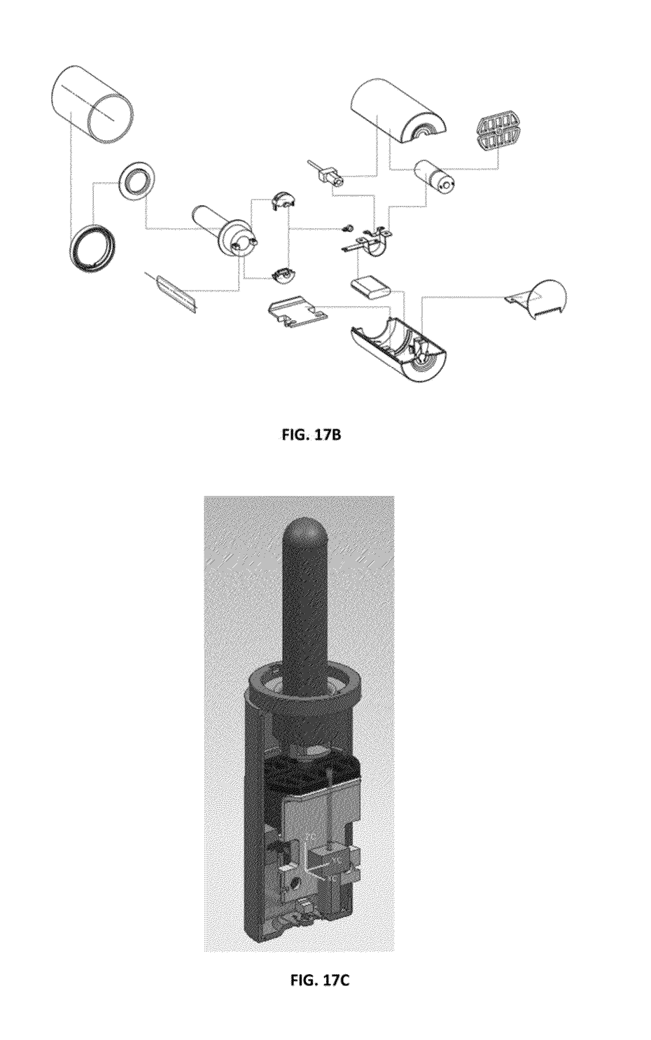

FIGS. 17A, 17B, and 17C are depicting diagrams of the sexual stimulation device simulating the sex organ of a male according to another embodiment of the present invention. Referring to FIG. 17A, the sexual stimulation device 1400 may be a sex toy simulating the sex organ a male and the sex toy may be usually for female such as a masturbation rod. The sexual stimulation device 1400 may comprise a control module 1410, an actuator 1420 and a case 1430 enclosing the control module 1410 and the actuator 1420. The control module 1410 may comprise a printed circuit board (PCB) mounting a MCU 1411, a pressure sensor 1412, a wireless module 1413 and a battery 1414 connected to the PCB. The actuator 1420 may comprise an air bag disposed inside of a silicone penis generally for the insertion of the user's penis with an air pump and an air valve connected to the airbag respectively and a linear motor supporting the airbag. The air pump and the air valve may be controlled by the MCU 1411 for inflating and/or deflating the airbag to deform the silicone penis. The linear motor 1421 may also be controlled by the MCU 1411 for moving the silicone penis to stretch out from the case 1430 and return back to the case 1430. The pressure sensor 1412 may be positioned in contact with the air inside of the airbag for measurement of the inner pressure of the airbag. Referring to FIGS. 17B and 17C, the actuator 1420 may comprise two airbags mount respective to two half cases of the case 1430, and the two airbags may be inserted into the silicone penis. The bottom and the printed circuit board of the control module 1410 may be mounted on one of the half cases and the air pump and the linear motor 1421 may be mounted on the other half cases. The battery 1414 may be disposed on the printed circuit board. After assembling the half cases together, a ring may be disposed on the top of the two half cases to secure the half cases. A cap may cover the silicone penis and the top of the case 1430 for keeping the silicone penis in good condition when the sexual stimulation device 1400 is not operated.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. An interactive simulation device for providing actions of interaction between a user and a target object, comprising:
a contacting part for contacting with the user;
a communication module for accessing a network to receive first interaction data representing the action of the target object to the user;
a processor electrically connected to the memory and the communication module and configured to control the communication module to communicate with an interaction data source via the network and receive the first interaction data from the interaction data source;
a memory for storing the received first interaction data; and
an actuating unit positioned against to the contacting part for driving the contacting part to perform actions to the user according to the first interaction data.

2. The interactive simulation device according to claim 1, further comprising a sensing unit for sensing the feedback of the first interaction data while the contacting part performing actions to the user according to first interaction data, and wherein the processor is further configured to generate the second interaction data according to the feedback and control the communication module to transmit the second interaction data to the interaction data source.

3. The interactive simulation device according to claim 2, wherein the sensing unit is positioned against to the contacting part for sensing the feedback of the first interaction data from the contacting part.

4. The interactive simulation device according to claim 1, wherein a media device is connected to the interactive simulation device, and wherein the media device is configured to receive first media data and the first interaction data and transmit the first interaction data to the interactive simulation device.

5. The interactive simulation device according to claim 1, wherein the processor is further configured to receive identification data from the interaction data source through the communication module, verify the identification data and determine whether the actuating unit to drive the contacting part according to the verification result.

6. An interaction module for providing actions of interaction between a user and a target object, comprising:
a communication unit for accessing a network to receive first interaction data representing the action of the target object to the user;
a processor electrically connected to the memory and the communication module and configured to control the communication module to communicate with an interaction data source via the network and receive the first interaction data from the interaction data source;
a memory for storing the received first interaction data; and
wherein the interaction module is implemented in an interactive simulation device comprising a contacting part for contacting with the user and an actuating unit positioned against to the contacting part for driving the contacting part to perform actions to the user according to the first interaction data.

7. The interaction module according to claim 8, further comprising a sensing unit for sensing the feedback of the first interaction data while the contacting part performing actions to the user according to first interaction data, and wherein the processor is further configured to generate the second interaction data according to the feedback and control the communication unit to transmit the second interaction data to the interaction data source.

8. The interaction module according to claim 7, wherein the sensing unit is positioned against to the contacting part for sensing the feedback of the first interaction data from the contacting part.

9. The interaction module according to claim 6, wherein the processor is further configured to receive identification data from the interaction data source through the communication unit, verify the identification data and determine whether the actuating unit to drive the contacting part according to the verification result.

10. The interaction module according to claim 6, wherein interactive simulation device is a sexual stimulation device for performing actions to the user's body and the contacting part of the sexual stimulation device is made of non-toxic material for contacting with the user's body.

11. A sexual stimulation device for performing actions of sexual interaction to a user's body, comprising:
a contacting part for contacting with the body of the user;
a communication unit for accessing a network to receive first sexual interaction data;
a processor electrically connected to the memory and the communication unit and configured to control the communication module to receive the first sexual interaction data via the network;
a memory for storing the received first sexual interaction data; and
an actuating unit for driving the contacting part to perform actions to the user according to the first sexual interaction data.

12. The sexual stimulation device according to claim 11, further comprising a sensing unit for sensing the user's body and generating sensor data accordingly, and wherein the processor is further configured to generate the second sexual interaction data according to the sensor data and control the communication unit to transmit the second sexual interaction data as response to the first sexual interaction data.

13. The sexual stimulation device according to claim 11, wherein the contacting part is in a shape of a rod to inserting into the body of the user.

14. The sexual stimulation device according to claim 11, wherein the contacting part is in a concave shape for enclosing the body of the user.

15. A system for enabling interaction of an interactive simulation device that performs actions of interaction to a user, comprising:
a request module for requesting interaction in a first network, receiving corresponding confirmation from the first network and sending an activation message to the interactive simulation device via a second network for acknowledging the interactive simulation device to receive interaction data;
an interaction module for receiving first media data and first interaction data from the first network;
a synchronization module for transmitting first interaction data to the interactive simulation device via the second network for the interactive simulation device to perform actions to the user according to the first interaction data; and
a play module for outputting the media data to the user.

16. The system according to claim 15, further comprising:
a media module for collecting and generating second media data from the environment; and
wherein the synchronization module receives second interaction data from the interactive simulation device via the second network; and
wherein the interaction module transmits the second media data and the second interaction data via the first network as response to the first media data and the first interaction data.

17. The system according to claim 15, wherein the first interaction data correlates to a steaming data set of the first media data in time sequence.

18. The system according to claim 15, wherein the wherein interactive simulation device is a sexual stimulation device for performing actions to the user's body, and wherein the first interaction data are instructions to the sexual stimulation device for performing actions corresponding to the first media data.

19. The system according to claim 15, wherein the first interaction data is encoded within the first media data, and wherein synchronization module further retrieves the first interaction data from the first media data.

20. The system according to claim 17, wherein the streaming data set is an image stream of a virtual character with motions in time sequence and the interaction data are instructions for the interactive simulation device to perform actions corresponding to the motions of the virtual character in time sequence.

21. A method for providing simulated interaction for a first interactive simulation device, comprising:
receiving a request for interaction and an address of the first interactive simulation device, and repeating the following steps:
retrieving first interaction data according to the request; and
transmitting the first interaction data to the first interactive simulation device according to the address for the first interactive simulation device performing actions according to the first interaction data.

22. The method according to claim 22, wherein the repeating steps further comprising:
retrieving first media data according to the request; and
transmitting the first media data to the first media device for the first media device playing the first media data and the first interactive simulation device performing actions simultaneously.

23. The method according to claim 22, wherein the first interaction data correlates to a steaming data set of the first media data in time sequence.

24. The method according to claim 22, wherein the request for interaction includes addresses of a second media device and a second interactive device, and the method further comprising:
transmitting the request to the second media device according to the addresses and receiving a confirmation from the second media device, and wherein the repeating steps further comprises:
retrieving the first media data and the first interaction data from the second media device and the second interactive simulation device for transmitting to the first media device and the first interactive simulation device respectively;
retrieving second media data and second interaction data from the first media device and the first interactive simulation device; and
transmitting the second media data to the second media device and the second interaction data to the second interactive simulation device respectively for the second media device playing the second media data and the second interactive simulation device performing actions according to the second interaction data simultaneously.

25. The method according to claim 22, further comprising:
receiving a request for a scenario from the first media device;
retrieving scenario data according to the request; and
wherein the repeating steps further comprises at least one of the following steps:
transmitting the scenario data with the first media data to the first media device for the first media device playing the scenario data with the first media data simultaneously; or
transmitting the scenario data with the first interaction data to the first interactive simulation device for the first interactive simulation device performing actions according to the scenario data and the first interaction data simultaneously.

26. The method according to claim 22, wherein the streaming data set is an image stream of a virtual character with motions in time sequence and the first interaction data are instructions for the first interactive simulation device to perform actions corresponding to the motions of the virtual character in time sequence.

27. The method according to claim 22, wherein the first interaction data is encoded within the first media data and the first media data are transmitted to the first media device and the first interactive simulation device in the repeating steps of the method.

28. The method according to claim 22, wherein the wherein interactive simulation device is a sexual stimulation device for performing actions to the user's body, and wherein the first interaction data are instructions to the sexual stimulation device for performing actions corresponding to the first media data.
